(19) United States
(12) Patent Application Publication
(10) Pub. No.: US 2012/0157579 A1
(43) Pub. Date: Jun. 21, 2012

(54) Azolium Ionomer Derivatives of Halogenated Polymers

(76) Inventors: J. Scott Parent, Kingston (CA); Ralph A. Whitney, Kingston (CA)

(21) Appl. No.: 13/315,975

(22) Filed: Dec. 9, 2011

Related U.S. Application Data
(60) Provisional application No. 61/421,532, filed on Dec. 9, 2010.

(51) Int. Cl. C08F 236/16; C08F 212/14; C08F 110/06; C08F 210/16; C08L 15/02; C08L 25/18; C08L 23/36; C08L 47/00; C08K 3/04; C08K 3/36; C08K 3/34; C08K 7/14; C08K 5/13; C08K 5/17; C08F 236/18; B82Y 30/00

(52) U.S. Cl. 524/35; 525/332.3; 525/333.4; 525/334.1; 525/331.7; 524/572; 524/576; 524/445; 524/323; 524/186; 977/700; 977/902

(57) ABSTRACT

Nucleophilic substitution reactions of halogenated polymers and azoles are used to produce derivatives of polyolefins bear pendant azolium ionomers. These uncured ionomers are useful in adhesive, antimicrobial applications, as well as in polymer composites and polymer blends. Furthermore, these azolium ionomers' ion pairs can bear reactive functionality, which provides access to further reactions that were unavailable using previous technology. Advantageously, such reactive ionomer derivatives of polyolefins can be cured by free radical and moisture-curing chemistry that was unaccessible to the halogenated polymer parent material.

### RELATED APPLICATION

This application claims the benefit of the filing date of U.S. Provisional Patent Application No. 61/421,532, filed on 9 Dec. 2010, the contents of which are incorporated herein by reference in their entirety.

### FIELD OF THE INVENTION

The present invention relates to polymer compositions that include ionic functionality.

### BACKGROUND OF THE INVENTION

Macromolecules having less than 5.0 mole percent ionic functionality, known herein as “ionomers”, are valued for their exceptional characteristics, which include a range of physical and chemical properties that are lacking in non-ionic analogues. Such characteristics include mechanical properties, adhesion to high surface energy solids (e.g., glass, metals), antimicrobial properties, and unusual solution viscosities. Since ionic functionalities are not effectively solvated by non-polar polyolefins, aggregation of polymer-bound ion pairs produces a non-covalent network of polymer chains. Presence of such networks contributes to improvements in mechanical properties such as strength and stiffness. Also, interaction of polymer-bound ion pairs with high surface energy solids (e.g., glass, metals) and polymer blend components enhances phase adhesion, thereby improving dispersion and compound reinforcement (J. S. Parent, A. Liskova, R. Resendes; Polymer 45, 8091-8096 (2004).

Ionomers have also been shown to provide antimicrobial properties that are lacking in polymers without ionic functionality (Y. Uemura, I. Moritake, S. Kurihara, T. Nonaka Journal of Applied Polymer Science (1999), 72(3), 371-378). As such, ionomer derivatives of halogenated polymers are valued in applications where surface anti-fouling and antibacterial activity are important.

Most commercially available ionomers are metal carboxylate or sulfonate salts of semi-crystalline thermoplastics. While these ionomers provide mechanical and adhesive properties discussed above, other properties such as creep and stress relaxation may be improved greatly by cross-linking to generate thermoset derivatives. In the case of amorphous elastomeric ionomers, cross-linking is required for most practical applications since in their uncured state, these rubbery ionomers exhibit excessive creep when subjected to a sustained load, owing to lability of ion-pair aggregates that give these materials strength. Cross-linking of polymer chains into a covalent network yields elastomeric thermosets with improved physical properties. Using existing technology, cross-linking is accomplished using reactions that operate on (i.e., form covalent bonds to) the polymer backbone, as opposed to operating on ionic functionality bound pendant to the backbone.

Accordingly, using existing technology, chemical reactions that cannot be applied to the polymer backbone of an ionomer cannot be used to cure the material. For example, using existing technology, an ionomer with a polyolefin backbone cannot be moisture-cured. Furthermore, ionomers with polyisobutylene or polypropylene backbones cannot, using existing methods, be cross-linked efficiently using free radical chemistry. This limitation restricts the field of use of such materials. Therefore, there is a need for ionomers having pendant (i.e., non-polymer backbone) ion pairs that participate in free-radical and moisture cure reactions.

### SUMMARY OF THE INVENTION

Described herein is an azolium ionomer comprising:

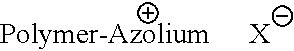

where X is an anion.

Also described herein is an azolium ionomer of formula (12),

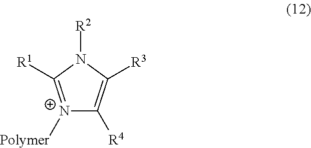

wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear one or more functional moieties; R² is a substituted or unsubstituted olefin, a substituted or unsubstituted C₁ to about C₁₆ aliphatic group, a substituted or unsubstituted C₁ to about C₁₆ aryl group, or a combination thereof, and optionally bears one or more functional moieties; and optionally, any combination of R¹, R², R³ and R⁴ together with the azole ring atoms to which they are bonded form a cyclic structure.

In various embodiments the azolium cation may be 1-decyl-2-methyl-3-alkylimidazolium, 1-(2-hydroxyethyl)-3-alkyl imidazolium, 1-butyl-3-alkyl-benzimidazole, N-butyl imidazolium, N-(trimethylsilyl)imidazolium, N-decyl-2-methylimidazolium, or N-hydroxyethyl imidazolium, N-(3-trimethoxysilylpropyl)imidazolium, N-vinylimidazolium, 2-(imidazol-1-yl)ethyl 2-methyl-2-propenoate, 1-butylbenzimidazolium, or any combination thereof.

Also described herein is an azolium ionomer of formula (13),

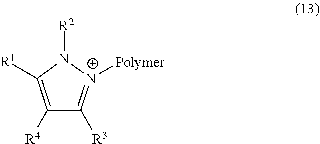

wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear a functional moiety; R² is a substituted or unsubstituted C₁ to about C₁₆ aliphatic group, a substituted or unsubstituted C₁ to about C₁₂ aryl group, or a combination thereof, and optionally bears a functional moiety; and optionally, any combination of R¹, R², R³ and R⁴ together with the azole ring atoms to which they are bonded form a cyclic structure.

In various embodiments the azolium cation may be N-(3-trimethoxysilylpropyl)pyrazole, N-vinylpyrazole, or a combination thereof.

Also described herein is an azolium ionomer of formula (14),

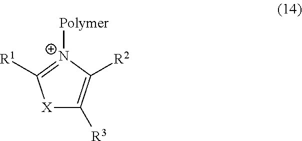

wherein X is sulphur or oxygen; R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality moiety; and optionally, R² and R³ taken together with the azole ring atoms to which they are bonded form a cyclic structure. In various embodiments the azolium cation may be oxazolium, benzothiazolium, or a combination thereof.

In one embodiment the azolium cation is a triazolium. Also described herein is an azolium ionomer of formula (15),

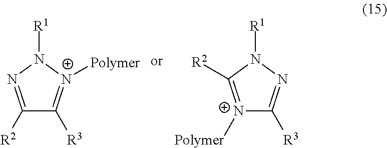

wherein R¹ is a substituted or unsubstituted C₁ to about C₁₆ aliphatic group, a substituted or unsubstituted C₁ to about C₁₆ aryl group, or a combination thereof, and optionally bears a functional moiety; R² and R³ are independently hydrogen, silane, a substituted or unsubstituted C₁ to about C₁₆ aliphatic group, a substituted or unsubstituted C₁ to about C₁₂ aryl group, or a combination thereof, and optionally bear a functional moiety; and optionally, any combination of R¹, R², and R³ together with the azole ring atoms to which they are bonded form a cyclic structure.

In various embodiments the triazolium cation may be

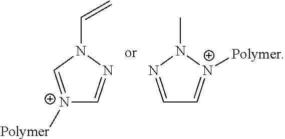

In the above embodiments the polymer moiety may be a derivative of BIIR, CIIR, BIMS, polychloroprene, halogenated EPDM (ethylene propylene diene monomer), halogenated polypropylene, halogenated polyethylene, halogenated ethylene-propylene copolymers, or a combination thereof.

An azolium ionomer as described herein may further comprise filler.

The filler may comprise carbon black, silica, clay, glass fibre, polymeric fibre, finely divided minerals, crystalline cellulose, or a combination thereof. The amount of filler may be from about 10 to about 60 wt %. The amount of filler may be from about 20 to about 45 wt %. The filler may comprise nano-scale filler. The nano-scale filler may comprise exfoliated clay platelets, sub-micron particles of carbon black, sub-micron particles of siliceous fillers, or a combination thereof. The amount of nano-scale filler may be from about 0.5 to about 30 wt %, or about 2 to about 10 wt %.

An azolium ionomer as described herein may further comprise antioxidant, wax, reinforcing filler, non-reinforcing filler, ultraviolet radiation stabilizer, anti-ozone stabilizing compound, tackifier, oil, soap, or a combination thereof. The antioxidant may comprise a phenoicl, an amine, or a combination thereof.

In various embodiments the anion may be carboxylate, sulphate, sulfonate, borate, phosphate, phosphonate, or phosphinate.

An azolium ionomer as described herein may comprise two anions, which may be, independently, carboxylate, sulfate, sulfonate, borate, phosphate, phosphonate, or phosphinate. An azolium ionomer as described herein may further comprise an anion, which may be persulfate, bis(dimethylallyl)pyrophosphate, etidronate, or conjugate base of adipic acid. The azolium ionomer may be IIR-g-BuImBr. The azolium ionomer may be IIR-g-vinylImBr.

An azolium ionomer as described herein may provide superior adhesion relative to a non-ionic analogue of the polymer. The azolium ionomer may provide superior adhesion to glass, mylar, plastic, mineral, metal, ceramic, or a combination thereof.

An azolium ionomer as described herein may reduce a population of organisms (e.g., bacteria, algae, fungi, mollusks, arthropods). An azolium ionomer as described herein may prevent accumulations of organisms (e.g., bacteria, algae, fungi, mollusks, arthropods). In various embodiments the organism comprises a microorganism. The microorganism may be a Gram-negative bacteria or Gram-positive bacteria.

An azolium ionomer as described herein may provide superior mechanical properties relative to an azolium ionomer comprising a non-ionic analogue of the polymer. In one embodiment, an azolium ionomer provides superior static properties or superior dynamic properties. In another embodiment, an azolium ionomer provides both superior static properties and superior dynamic properties. The static property may be, for example, compression set resistance. The dynamic property may be, for example, flex fatigue.

Also described herein is a method of making azolium ionomer, comprising: reacting halogenated polymer and an azole. The azole may be a compound of formula (1):

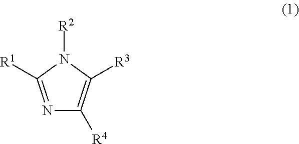

wherein R¹, R³ and R⁴ are independently hydrogen, silane, a substituted or unsubstituted C₁ to about C₁₆ aliphatic group, a substituted or unsubstituted C₁ to about C₁₂ aryl group, or a combination thereof, and optionally bear a functionality; R² is a substituted or unsubstituted olefin, a substituted or unsubstituted C₁ to about C₁₆ aliphatic group, a substituted or unsubstituted C₁ to about C₁₂ aryl group, or a combination thereof, and optionally bears a functionality; and optionally, R³ and R⁴ together with the C═C unit to which they are bonded form a cyclic structure.

According to the method described herein, the azole may comprise N-butyl imidazole, N-(trimethylsilyl)imidazole, N-decyl-2-methylimidazole, N-hydroxyethyl imidazole, N-(3-trimethoxysilylpropyl)imidazole, N-vinylimidazole, 2-(imidazol-1-yl)ethyl 2-methyl-2-propenoate, 1-butylbenzimidazole, or a combination thereof. According to the method described herein, the azole may be a pyrazole of formula (2):

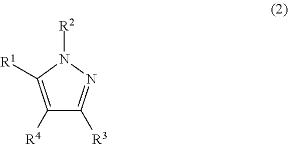

wherein R² is a substituted or unsubstituted olefin, a substituted or unsubstituted C₁ to about C₁₆ aliphatic group, a substituted or unsubstituted C₁ to about C₁₂ aryl group, or a combination thereof, and optionally bears a functionality; R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; and optionally, any combination of R¹, R², R³ and R⁴ together with pyrazole ring atoms to which they are bonded form a cyclic structure.

According to the method described herein, the azole may comprise N-(3-trimethoxysilylpropyl)pyrazole, N-vinylpyrazole, or a combination thereof.

According to the method described herein, the azole may be of formula (3)

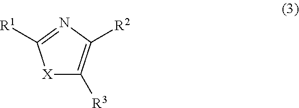

wherein X is a heteroatom that is non-nitrogen (e.g., sulphur, oxygen); R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; and optionally, R² and R³ together with the azole ring atoms to which they are bonded form a cyclic structure.

According to the method described herein, the azole may be oxazole, benzothiazole, or a combination thereof. In one embodiment, the azole is a triazole. The triazole may be

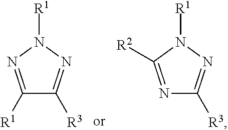

wherein R¹ is a substituted or unsubstituted olefin, a substituted or unsubstituted C₁ to about C₁₆ aliphatic group, a substituted or unsubstituted C₁ to about C₁₆ aryl group, or a combination thereof, and optionally bears a functionality; R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; and optionally, any combination of R¹, R² and R³ together with the triazole ring atoms to which they are bonded form a cyclic structure. The triazole may be

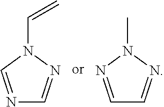

According to the method described herein, the halogenated polymer may comprise BIIR, CIIR, BIMS, chlorinated polyethylene, or a combination thereof. The method may further comprise using filler. The filler may comprise carbon black, silica, clay, glass fibres, polymeric fibres, finely divided minerals, or a combination thereof. According to the method described herein, one or more other additives may be added to the mixture. The one or more other additive may be an antioxidant, wax, reinforcing filler, non-reinforcing filler, ultraviolet radiation stabilizer, anti-ozone stabilizing compound, tackifier, oil, soap, or a combination thereof. The antioxidant may comprise a phenolic, an amine, or a combination thereof. The method may further comprise replacing halo anions with at least one non-halo counterion. The non-halo counterion may be carboxylate, sulphate, sulfonate, borate, phosphate, phosphonate, or phosphinate.

The method may further comprise replacing halo anions with at least two non-halo counterions. In one embodiment, the counterion is persulfate.

Also described herein is a cured polymeric product prepared by subjecting an azolium ionomer as described herein to an appropriate trigger for curing. The cured polymeric product may include an azolium ionomer adapted for moisture-curing, wherein an appropriate trigger may be exposure to moisture. The azolium ionomer adapted for moisture-curing may comprise: a polymer-bound imidazolium, pyrazolium, oxazolium, thiazolium, triazolium, or a combination thereof, and silane functionality.

In one embodiment the azolium ionomer adapted for moisture-curing comprises 1-(3-trimethoxysilylpropyl)-3-alkyl-imidazolium.

Exposure to moisture may include exposure to water, a humid atmosphere, or both. Exposure to moisture may comprise heat in the presence of a moisture-generating component. The moisture-generating component may comprise a hydrated compound, aluminum trihydroxide, a mixture of metal oxide and a carboxylic acid, or any combination thereof. The hydrated compound may comprise gypsum, MgSO₄.7H₂O, or a combination thereof.

In one embodiment the mixture of metal oxide and a carboxylic acid comprises ZnO and stearic acid. The cured polymeric product may include an azolium ionomer adapted for radical-curing and the appropriate trigger is exposure to a radical generating technique.

Exposure to a radical generating technique may include UV light, a chemical initiator (e.g., organic peroxide, inorganic peroxide), thermo-mechanical means, radiation, electron bombardment, or a combination thereof.

The cured polymeric product may include an azolium ionomer mixed with a co-agent prior to subjecting the mixture to an appropriate trigger.

For the azolium ionomer mixed with a co-agent, the trigger may be exposure to a radical generating technique and the co-agent may comprise trimethylolpropane triacrylate, triallyl trimellitate, N,N′-m-phenylenedimaleimide, 1-vinyl-3-decyl-imidazolium bromide, or a combination thereof. The radical-curing azolium ionomer may comprise a C═C functionality that oligomerizes when subjected to a radical generating technique. The C═C functionality may be vinyl, styrenic, acrylic, olefin, diene, vinyl, maleate, itaconate, cinnamate moieties, or a combination thereof. The azolium ionomer that comprises an oligomerizable C═C functionality may be 1-vinyl-3-alkyl-imidazolium chloride, and the polymer may comprise a polymer backbone derived from BIIR, CIIR, BIMS, halogenated EPDM (ethylene propylene diene monomer), polychloroprene, halogenated polyethylene, halogenated polypropylene, halogenated ethylene-propylene copolymer, or a combination thereof.

In one embodiment the azolium ionomer that comprises an oligomerizable C═C functionality is 1-vinyl-3-allyl-imidazolium bromide:

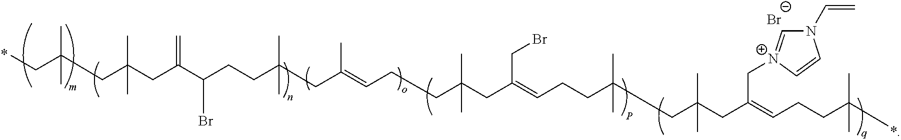

In one embodiment the azolium ionomer that comprises an oligomerizable C═C functionality is 1-vinyl-2-alkyl-pyrazolium bromide ion pairs, and the polymer is polypropylene:

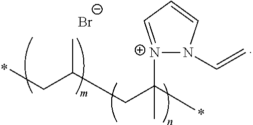

The radical curable C═C functionality may be a methacrylate group.

In one embodiment the azolium ionomer is:

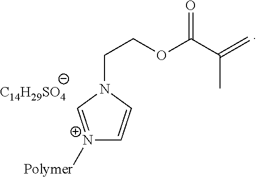

In one embodiment the azolium ionomer may a BIMS-derived backbone bearing 1-(2-ethylmethacrylate)-3-benzykimidazolium bromide.

Also described herein is a cured polymeric product derived from crosslinking azolium ionomers [1-(3-trimethoxysilylpropyl)-3-alkyl-imidazolium] [Br⁻], IIR-g-BuImBr, or IIR-g-VImBr.

A cured polymeric product prepared as described herein may provide superior adhesion relative to a non-ionic analogue of the polymer. The azolium ionomer may provide superior adhesion to glass, mylar, plastic, mineral, metal, ceramic, or a combination thereof.

The cured polymeric product may reduce a population of organisms (e.g., bacteria, algae, fungi, mollusks, arthropods). The cured polymeric product may prevent an accumulation of organisms (e.g., bacteria, algae, fungi, mollusks, arthropods). The organisms may comprise microorganisms. The microorganisms may be Gram-negative bacteria or Gram-positive bacteria.

A cured polymeric product as described herein may provide superior mechanical properties relative to a cured polymeric product comprising a non-ionic analogue of the polymer. In one embodiment, a cured polymeric product provides superior static properties or superior dynamic properties. In another embodiment, a cured polymeric product provides both superior static properties and superior dynamic properties. The static property may be, for example, compression set resistance. The dynamic property may be, for example, flex fatigue.

Also described herein is a process for preparing crosslinked polymer, comprising: mixing a halogenated polymer and an azole to form a mixture; and subjecting the mixture to an appropriate trigger.

Also described herein is a process for preparing crosslinked polymer, comprising: subjecting an azolium ionomer to a curing technique.

The curing technique may operate on the azolium ionomer polymer backbone.

Also described herein is a process for preparing crosslinked polymer, comprising: subjecting an azolium ionomer to an appropriate trigger. According to this process, the azolium ionomer may be an azoilum ionomer as described herein.

The azole may comprise a functionality that is capable of crosslinking under moisture-curing conditions (“moisture-curing azole”) and the appropriate trigger may be exposure to moisture.

The moisture-curing azole may comprise imidazolium, pyrazolium, oxazolium, thiazolium, triazolium, or a combination thereof, and silane functionality. In one embodiment the moisture-curing azole is 1-(3-trimethoxysilylpropyl)-3-alkyl-imidazolium.

Exposure to moisture may comprise exposure to a humid atmosphere or exposure to water.

Exposure to moisture may comprise heat in the presence of a moisture-generating component.

The moisture-generating component may comprise a hydrated compound (e.g., gypsum, MgSO₄.7H₂O), aluminum trihydroxide, a mixture of metal oxide and a carboxylic acid (e.g., ZnO and stearic acid), or any combination thereof.

The azole may comprise a functionality that is capable of crosslinking under radical-curing conditions and the appropriate trigger may be exposure to a radical generating technique.

The radical generating technique may comprise UV light, a chemical initiator (e.g., organic peroxide, inorganic peroxide), thermo-mechanical means, radiation, electron bombardment, or a combination thereof.

The azolium ionomer may be mixed with a co-agent prior to subjecting the mixture to the appropriate trigger.

The trigger may be exposure to a radical generating technique and the co-agent may comprise trimethylolpropane triacrylate, triallyl trimellitate, N,N′-m-phenylenedimaleimide, 1-vinyl-3-decyl-imidazolium bromide, or a combination thereof.

The radical-curing azolium ionomer may comprise a C═C functionality that oligomerizes when subjected to a radical generating technique.

The C═C functionality may be vinyl, styrenic, acrylic, olefin, diene, vinyl, maleate, itaconate, cinnamate moieties, or a combination thereof.

The azolium ionomer that comprises an oligomerizable C═C functionality may be 1-vinyl-3-alkyl-imidazolium chloride, and the Polymer may be a CIIR-derived polymer backbone or a chloroprene-derived polymer backbone.

In one embodiment the azolium ionomer that comprises an oligomerizable C═C functionality may be 1-vinyl-3-allyl-imidazolium bromide:

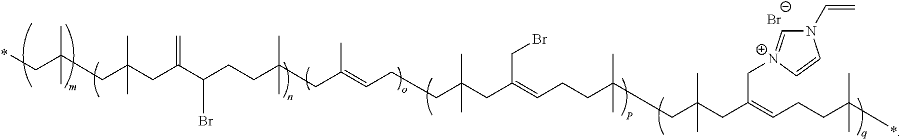

The azolium ionomer that comprises an oligomerizable C═C functionality may be 1-vinyl-2-alkyl-pyrazolium bromide ion pairs, and the Polymer may be polypropylene:

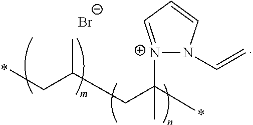

In one embodiment the radical curable C═C functionality is a methacrylate group.

In one embodiment the azolium ionomer is:

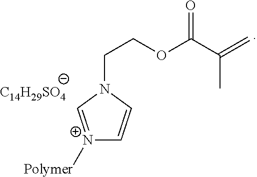

The azolium ionomer may be a BIMS-derived backbone bearing 1-(2-ethyl methacrylate)-3-benzyl-imidazolium bromide. The cured polymeric product may be made by a method as described herein.

Also described herein is a kit comprising a halogenated polymer; an azole; and instructions comprising directions to subject a mixture of the halogenated polymer and the azole to a trigger to form a crosslinked polymer. In a kit as described herein, the azole may be a compound of formula (1) as defined herein, a compound of formula (2) as defined herein, or a compound of formula (3) as defined herein. The kit, wherein the halogenated polymer may be BIIR, CIIR, BIMS, chloroprene, or a combination thereof. The kit may further comprise filler. The kit, wherein the filler may comprise carbon black, silica, clay, glass fibre, polymeric fibre, finely divided minerals, or a combination thereof.

The kit may further comprise a molded container suitable for use when curing azolium ionomer.

The instructions may comprise printed material, text or symbols provided on an electronic-readable medium, directions to a web site, or electronic mail.

Also described herein is an article comprising azolium ionomer.

The article may provide superior adhesion relative to a non-ionic analogue of the polymer.

The article may provide superior adhesion to glass, mylar, plastic, mineral, metal, ceramic, or a combination thereof.

The article may reduce a population of organisms (e.g., bacteria, algae, fungi, mollusks, arthropods). The article may prevent an accumulation of organisms (e.g., bacteria, algae, fungi, mollusks, arthropods). The organisms may comprise a microorganism. The microorganism may be Gram-negative bacteria or Gram-positive bacteria.

The article may provide superior mechanical properties relative to an article comprising a non-ionic analogue of the polymer. In one embodiment, the article provides superior static properties or superior dynamic properties. In another embodiment, the article provides both superior static properties and superior dynamic properties. The static property may be, for example, compression set resistance. The dynamic property may be, for example, flex fatigue.

The article may comprise fuel cell membrane, pharmaceutical stopper, syringe fitting, ion-exchange resin, separation membrane, bathroom safety equipment, garden equipment, spa equipment, water filtration equipment, caulking, sealant, grout, contact cement, adhesive, pressure sensitive adhesive, tank liner, membrane, packaging material, cell culture equipment, light switch, exercise equipment, railing, sports equipment, steering wheel, writing tool, luggage, o-ring, tire inner liner, tire tread, thermoplastic vulcanizate (TPV), gasket, appliance, baby product, bottle, lid, toilet seat, bathroom fixture, flooring, surface including surface for food preparation, utensil, handle, grip, doorknob, container for food storage, gardening tool, kitchen fixture, kitchen product, office product, pet product, water storage equipment, food preparation equipment, shopping cart, surfacing material, storage container including food storage container, footwear, protective wear, sporting gear, cart, dental equipment, door knob, clothing, handheld device, telephone, toy, container for fluid, catheter, keyboard, surface of vessel, surface of pipe, surface of duct, coating, food processing equipment, materials handling equipment (e.g., auger, conveyor belt), biomedical device, filter, additive, computer, dock, drilling platform, ship hull, underwater infrastructure, HVAC equipment, shower wall, shower flooring, implant, medical textile, tissue sealant, tissue adhesive, personal protective equipment, wetsuit, drysuit, respiratory mask, article to minimize biofouling, pacemaker, wound dressing, ice machine, water cooler, fruit juice dispenser, soft drink machine, piping, storage vessel, metering system, valve, fitting, attachment, filter housing, lining, barrier coating, insulation, chemical protective equipment, or biochemical protective equipment.

A further aspect of the invention is use of azolium ionomer. Yet another further aspect is use of cured polymeric product derived from curing azolium ionomer.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 is a schematic showing a synthetic methodology used to prepare an ionomer derivative of a halogenated elastomer via nucleophilic displacement of bromide from Bromobutyl rubber (BIIR) by N-butyl imidazole to yield an azolium ionomer.

FIG. 2 is a plot of concentration of the specified functionality versus time (min) which shows dynamics of solvent-free bromide displacement from BIIR by N-butylimidazole at 85° C.

FIG. 3 is a plot of concentration of the specified functionality which shows dynamics of displacement from BIIR by N-butylimidazole in solution at 100° C.

FIG. 4 is a plot of storage modulus G′ (kPa) versus time (min) for specified formulations, which shows accelerated sulfur curing at 160° C. of IIR and IIR-g-BuImBr (3° arc, 1 Hz).

FIG. 5 is a plot of storage modulus G′ (kPa) versus time (min) for specified formulations, which shows peroxide-initiated curing at 160° C. of IIR and IIR-g-BuImBr (0.3 wt % DCP, 3° arc, 1 Hz).

FIG. 6 is a plot of storage modulus G′ (kPa) versus time (min) for specified formulations, which shows peroxide-initiated curing at 160° C. of IIR-g-NVImBr at specified amounts of DCP (3° arc, 1 Hz).

FIG. 7 is a plot of storage modulus G′ (kPa) versus time (min) for specified formulations, which shows peroxide-initiated curing at 160° C. of IIR-g-NVImBr and its specified filler-reinforced formulations (0.5 wt % DCP, 3° arc, 1 Hz).

FIG. 8 is a plot of tensile strength (MPa) vs. elongation (%), which shows tensile stress-strain data for IIR-g-NVImBr and its specified filler-reinforced formulations (0.5 wt % DCP, 23° C., 500 mm/min elongation rate).

FIG. 9 is a plot of storage modulus G′ (kPa) versus time (min), which shows peroxide-initiated curing at 160° C. of IMS-g-NVImBr at specified amounts of DCP and a filler-reinforced formulation (3° arc, 1 Hz).

FIG. 10 is a plot of storage modulus G′ (kPa) versus time (min), which shows peroxide-initiated curing of IIR-g-NVImBr and IIR-g-NVImBr+DVImBr coagent (0.1 wt % DCP, 3° arc, 1 Hz).

FIG. 11 is a plot of storage modulus G′ (MPa) versus temperature for peroxide cured IIR-g-NVImBr and IIR-g-Acrylic Acid (3° arc, 1 Hz).

### DETAILED DESCRIPTION OF THE INVENTION

Aspects of the present invention include azolium ionomers. Another aspect of the invention is a method of preparing azolium ionomers using halogenated polymers and azoles. Further aspects of the present invention include methods of crosslinking azolium ionomers to generate thermoset derivatives. Further aspects include thermoset products derived from crosslinking azolium ionomers. The following terms will be used in the description of these aspects.

### DEFINITIONS

As used herein, “aliphatic” refers to saturated or unsaturated hydrocarbon moieties that are straight chain, branched or cyclic and, further, the aliphatic moiety may be substituted or unsubstituted.

As used herein, “aryl” refers to aromatic ring moieties that are typically five or six membered rings. Aryl includes heteroaryl. Large aryl moieties such as “a C₁₂ aryl group” encompasses fused ring systems.

As used herein, the term “azole” is a cyclic five-membered heteroaromatic compound having one nitrogen atom and at least one other non-carbon atom of either nitrogen, sulfur, or oxygen. Examples of azoles described herein include imidazoles, pyrazoles, oxazoles, thiazoles, and triazoles.

As used herein, the term “azolium ionomer” refers to polymer compositions comprising a polymer backbone and a plurality of azolium cations that are covalently-bound to the backbone in a pendant position, and a plurality of anionic counterions associated with the plurality of cations. The anions may be halo, or may be a variety of other moieties.

As used herein, the term “IIR” means polyisobutylene-co-isoprene), which is a synthetic elastomer commonly known as butyl rubber. As used herein, the term “BIIR” means brominated butyl rubber. As used herein, the term “CIIR” means chlorinated butyl rubber.

As used herein, the term “BIMS” means brominated poly(isobutylene-co-methylstyrene).

As used herein, the terms “curing”, “vulcanizing”, or “cross-linking” are used interchangeably and refer to formation of covalent bonds that link one polymer chain to another, thereby altering the properties of the material.

As used herein, the term “free radical curing” means cross-linking that is initiated by a radical generating technique.

As used herein, the term “functionality” is a chemical moiety that does not displace halide from a halogenated polymer during an ionomer synthesis, but rather performs a function following ionomer preparation. For example, a pendant group on an polymer that includes an —Si(OMe)₃ moiety can perform the function of binding to siliceous fillers. Alternately, a pendant group on a polymer that includes C═C unsaturation can perform the function of peroxide-initiated cross-linking. Non-limiting examples of functionalities include: silane, alkoxysilane, siloxane, alcohol, epoxide, ether, carbonyl, carboxylic acid, carboxylate, aldehyde, ester, anhydride, carbonate, tertiary amine, imine, amide, carbamate, urea, maleimide, nitrile, olefin, acrylate, methacrylate, itaconate, styrenic, borane, borate, thiol, thioether, sulfate, sulfonate, sulfonium, sulfite, thioester, dithioester, halogen, peroxide, hydroperoxide, phosphate, phosphonate, phosphine, phosphate, phosphonium, alkyl, and aryl.

As used herein, the term “halogenated polymer” means a polymer that includes a halogen-carbon electrophile that is reactive toward nitrogen nucleophiles.

As used herein, the term “heteroatom” refers to a non-carbon atom such as, for example, nitrogen, sulphur, oxygen.

As used herein, the term “ionic” refers to presence of charged moieties.

As used herein, the term “ionomer” refers to a macromolecule having less than 5.0 mole percent ionic functionality.

As used herein, the term “macromonomers” refers to isobutylene-rich elastomers that are capable of being cured using free-radical initiation methods.

As used herein, the term “moisture-generating component” is a compound that releases water upon heating and, although the released water participates in reactions, the remainder of the moisture-generating component is either non-reactive or does not inhibit reactions that lead to crosslinks between polymers.

As used herein, the term “N-nucleophile” refers to a compound comprising nitrogen bear a lone pair of electrons that undergoes a nucleophilic substitution reaction at an electrophilic site. This may occur, for example, at an allylic or benzylic site of a halogenated elastomer.

As used herein, the term “nucleophilic substitution” refers to displacement of a halide by a nucleophilic reagent and includes N-alkylation of azoles and the like.

As used herein, the terms “polymer backbone” and “main chain” mean the main chain of a polymer to which pendant group is attached. As used is structures shown herein, a connection to “Polymer” is not meant to be limiting, and may, for example, be a bond to polymer backbone.

As used herein, the term “radical generating technique” means a method of creating free radicals, including the use of a chemical initiator, organic peroxide, inorganic peroxide, photo-initiation, electron bombardment, radiation bombardment, thermo-mechanical processes, oxidation reactions or other techniques known to those skilled in the art.

As used herein “substituted” refers to the structure having one or more substituents. A substituent is an atom or group of bonded atoms that can be considered to have replaced one or more hydrogen atoms attached to a parent molecular entity. A substituent can be further substituted. In preferred embodiments, substituents are selected to perform a function.

A “trigger” is a change of conditions (e.g., introduction of water, change in temperature) that begins a chemical reaction or a series of chemical reactions.

### DESCRIPTION

Poly(isobutylene-co-isoprene), (“butyl rubber” or “IIR”), is an elastomeric random copolymer comprising isobutylene and small amounts of isoprene (1-3 mole %). Halogenated forms of IIR, which include brominated IIR (“BIIR”) and chlorinated IIR (“CIIR”) react more rapidly than unhalogenated forms when treated with standard nucleophilic reagents such as sulfur. The increased reactivity of halogenated IIR is due to the presence of electrophilic allylic halide functionality, which is susceptible to nucleophilic substitution. Similarly, brominated poly(isobutylene-co-methylstyrene) (“BIMS”) is an elastomeric material that provides good air impermeability and oxidative resistance, as well as heightened reactivity to nucleophiles, owing to electrophilic benzylic halide functionality within the polymer.

Isobutylene-rich elastomeric ionomers have been prepared by nucleophilic displacement of halide from BIIR by triphenylphosphine to yield quaternary phosphonium bromide ionomers (J. S. Parent, A. Penciu, S. A. Guillen-Castellanos, A. Liskova, R. A. Whitney, (2004) Macromolecules 37: 7477-7483). Quaternary phosphonium salts have been similarly prepared by reaction of BIMS with triphenylphosphine (P. Arjunan, H. C. Wang, (1997) Polymer Material Science and Engineering 76: 310-311). These ionomers have a plurality of ion pairs located pendant to the polymer backbone, each having the generic structure illustrated below.

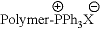

A deficiency of phosphine-based chemistry is the limited range of air-stable, functional phosphines that are suitable for producing IIR-derived ionomers. Other than air-stable triphenylphosphine, which bears unreactive phenyl substituents, inexpensive phosphines that are air-stable and that bear useful reactive functionalities are not commercially (i.e., readily) available, and must therefore be prepared at great expense.

Inexpensive tertiary amines are much more abundant, and are available with a wide range of chemical functionality. They have been used to prepare quaternary ammonium bromide derivatives of BIIR (J. S. Parent, A. Liskova, R. A. Whitney and R. Resendes (2005) Journal of Polymer Science—Part A: Polymer Chemistry 43: 5671-5679) and of BIMS (A. H. Tsou, I. Duvdevani, P. K. Agarwal; Polymer 45, 3163-3173, 2004). These ionomers have pendant ion pairs of the generic structure illustrated below.

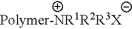

The thermal instability of such N-alkylation products requires the use of excess nucleophile to drive reactions of halogenated polymers and tertiary amines toward the desired ionomer. In the absence of excess amine, ammonium halide ion pairs are unstable. However, when excess amine is present, the resulting ionomeric product has an undesirable odour (e.g., fishy smell), discolouration and certain toxicological problems.

Other nucleophilic nitrogen compounds have been examined in the context of ionomer formation. Pyridines have been reacted with BIIR and CIIR in a solution process to produce ionomers that do not bear reactive functionality, but provide good tensile properties (I. Kuntz, R. Park, F. P. Baldwin; U.S. Pat. No. 3,011,996 (1961)). Similar to the quaternary ammonium ionomer syntheses described above, a large excess of pyridine is required along with long reaction times to produce the desired ion pair. When excess pyridine is present, the resulting ionomeric product has an undesirable odour, and certain toxicological problems.

Amidines, imines and oxazolines have also been examined as potential nitrogen nucleophiles for the synthesis of ionomers (M. Faba, M.Sc. Thesis, Queen's University, Kingston, Ontario, Canada (2010)). While these reagents can be N-alkylated by halogenated polymers to give ionomer intermediates, resulting ion pairs are highly sensitive to water. Hydrolysis of the ion pair leads to a loss of the desirable ionomer properties described above.

As discussed above, using previously known technology, it was not possible to prepare derivatives of halogenated polymers by N-alkylation of nitrogen nucleophiles to yield ion pairs that were stable with respect to dealkylation and/or hydrolysis. Therefore, there is a need for nitrogen nucleophiles that react irreversibly with halogenated polymers to give ion pairs that are not destroyed when exposed to moisture, heat, and/or other chemical reagents. There is a particular need for such nitrogen nucleophiles that bear functionality to enable an ionomer to engage in chemistry that cannot be applied to its polymer backbone.

Surprisingly, it has been discovered that reactions of halogenated polymers with azoles yields azolium halide ion pairs that provide unusual thermal and chemical stability. As described herein, such azolium ionomer derivatives of halogenated polymers have been prepared and characterized. Methods of preparing such azolium ionomer derivatives of halogenated polymers are described as well as methods of crosslinking such ionomers. Further, crosslinked products of azolium ionomers have been prepared and properties of such cured products are described herein.

### Halogenated Polymer

“Halogenated polymer” as used herein includes polymers comprising non-electrophilic mers that do not react with the azoles described herein, and electrophilic halogen-comprising mers that do react with nitrogen nucleophiles. The non-electrophilic mer composition within a halogenated polymer is not particularly restricted, and may comprise any polymerized olefin monomer. As used herein, the term “olefin monomer” is has a broad meaning and encompasses α-olefin monomers, diolefin monomers and polymerizable monomers comprising at least one olefin.

In certain embodiments, the olefin monomer is an α-olefin monomer. α-Olefin monomers are well known in the art and the choice thereof for use in the present process is within the purview of a person skilled in the art. Preferably, α-olefin monomers of the invention include isobutylene, ethylene, propylene, 1-butene, 1-pentene, 1-hexene, 1-octene, and branched isomers thereof. Other preferred α-olefin monomers of the invention include styrene, α-methylstyrene, para-methylstyrene, acrylonitrile, vinylacetate, and combinations thereof. Particularly preferred α-olefin monomers include isobutylene and para-methylstyrene.

In other embodiments, the olefin monomer comprises a diolefin monomer. Diolefin monomers are well known in the art and the choice thereof for use in the present process is within the purview of a person skilled in the art. Non-limiting examples of suitable diolefin monomers include: 1,3-butadiene; isoprene; divinyl benzene; 2-chloro-1,3-butadiene; 2,3-dimethyl-1,3-butadiene; 2-ethyl-1,3-butadiene; piperylene; myrcene; allene; 1,2-butadiene; 1,4,9-decatrienes; 1,4-hexadiene; 1,6-octadiene; 1,5-hexadiene; 4-methyl-1,4-hexadiene; 5-methyl-1,4-hexadiene; 7-methyl-1,6-octadiene; phenylbutadiene; pentadiene; and combinations thereof. In another embodiment, the diolefin monomer is an alicyclic compound. Non-limiting examples of suitable alicyclic compounds include: norbornadiene and alkyl derivatives thereof; 5-alkylidene-2-norbornene; 5-alkenyl-2-norbornene; 5-methylene-2-norbornene; 5-ethylidene-2-norbornene; 5-propenyl-2-norbornene; 1,4-cyclohexadiene; 1,5-cyclooctadiene; 1,5-cyclododecadiene; methyltetrahydroindene; dicyclopentadiene; bicyclo [2.2.1] hepta-2,5-diene; and combinations thereof. Preferred diolefin monomers include butadiene, isoprene and 2-chloro-1,3-butadiene. Of course it is possible to utilize mixtures of the various types of olefin monomers described hereinabove.

In an embodiment, the olefin is a mixture of isobutylene and at least one diolefin monomer. A preferred such monomer mixture comprises isobutylene and isoprene. In this embodiment, it is preferred to incorporate into the preferred mixture of isobutylene and isoprene from about 0.5 to about 7 mole percent of the diolefin monomer.

In an embodiment, the olefin is a mixture of isobutylene and at least one α-olefin. A preferred such monomer mixture comprises isobutylene and para-methylstyrene. In this embodiment, it is preferred to incorporate into the mixture of isobutylene and para-methylstyrene from about 0.5 to about 3 mole percent of the α-olefin monomer.

As one of skill in the art of the invention will recognize, the number of halogen-comprising electrophilic groups per polymer chain will affect the maximum concentration of ionic functionality within an azolium ionomer. Typically, the electrophile content of a halogenated polymer is from about 0.1 to about 100 groups per 1000 polymer backbone carbons. In some cases, electrophile content is between 5 and 50 groups per 1000 polymer backbone carbons.

Selection of a halogenated electrophile is within the purview of a person skilled in the art, and can be made from a group consisting of alkyl halide, allylic halide and benzylic halide, and combinations thereof. Non-limiting, generic structures for these examples are illustrated below, where X represents a halogen and R¹-R⁵ are independently hydrogen or aliphatic groups that may bear functionality.

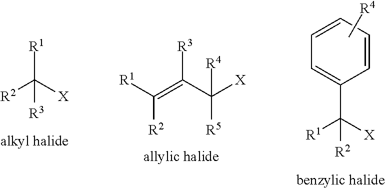

In another embodiment, a halogenated polymer comprising a random distribution of isobutylene mers, isoprene mers and allylic halide electrophiles

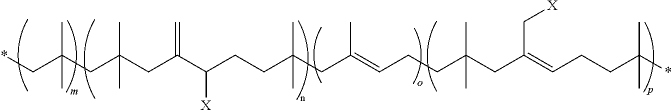

where X is a halogen, including bromine, chlorine and iodine, and combinations thereof. Polymers comprising about 90-98 mole % isobutylene mers, 1-7 mole % isoprene mers, and 1-3 mole % allylic halide mers are known as halogenated butyl rubber. This includes halogenated polymers derived from “high isoprene” grades of butyl rubber that have greater isoprene contents than conventional butyl rubber materials.

In another embodiment, the halogenated polymer comprises a random distribution of isobutylene mers, para-methylstyrene mers and a benzylic halide electrophile

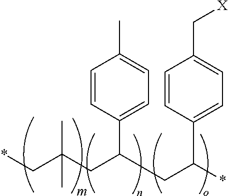

where X is a halo group where preferred halogens include bromine and chlorine, and combinations thereof. Polymers comprising about 94-97 mole % isobutylene mers, 1-3 mole % para-methylstyrene mers, and 1-3 mole % benzylic bromide mers are known as BIMS.

In an embodiment, the halogenated polymer comprises a random distribution of 2-chloro-1,3-butadiene mers and allylic halide electrophiles.

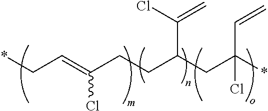

This polymer is commonly known as polychloroprene.

In an embodiment, the halogenated polymer comprises a random distribution of propylene mers and alkyl halide electrophiles

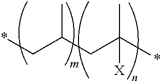

where X is a halo group where preferred halogens include bromine and chlorine, and combinations thereof. When X is chloride, this polymer is commonly known as chlorinated polypropylene.

In an embodiment, the halogenated polymer comprises a random distribution of ethylene mers and alkyl halide electrophiles

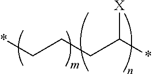

where X is a halo group where preferred halogens include bromine, chlorine and iodine, and combinations thereof. When X is chloride, this polymer is commonly known as chlorinated polyethylene.

Preferably the halogenated polymers used in the present invention have a molecular weight (Mn) in the range from about 4,000 to about 500,000, more preferably from about 10,000 to about 200,000. It will be understood by those of skill in the art that reference to molecular weight refers to a population of polymer molecules and not necessarily to a single or particular polymer molecule.

### Azoles

As defined above, the term “azole” is a cyclic five-membered heteroaromatic compound having one nitrogen atom and at least one other non-carbon atom of either nitrogen, sulfur, or oxygen. In certain embodiments of the invention, azole is an imidazole, which is a compound of formula (1) shown below:

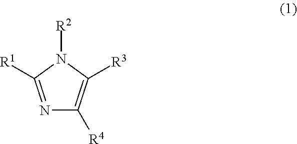

wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear a functionality;

R² is non-hydrogen, and is independently a substituted or unsubstituted C₁ to about C₁₆ aliphatic group, a substituted or unsubstituted C₁ to about C₁₆ aryl group, or a combination thereof, and optionally bears a functionality; and

optionally, R³ and R⁴, together with the C═C unit to which they are attached, form a cyclic structure.

In certain embodiments of compounds of formula (1), R² is a substituted or unsubstituted olefin.

Non-limiting examples of compounds of formula (1) include the following imidazoles: N-butyl imidazole, N-(trimethylsilyl)imidazole, N-decyl-2-methylimidazole, and N-hydroxyethyl imidazole, whose structures are illustrated below, respectively:

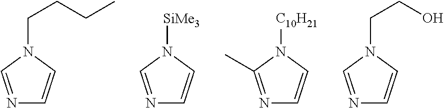

Further non-limiting examples of compounds of formula (1) include: N-(3-trimethoxysilylpropyl)imidazole, N-vinylimidazole, 2-(imidazol-1-yl)ethyl 2-methyl-2-propenoate, and 1-butylbenzimidazole, whose structures are illustrated below, respectively:

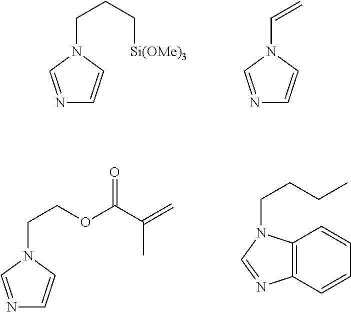

In certain embodiments of the invention, the azole is a pyrazole of formula (2) shown below:

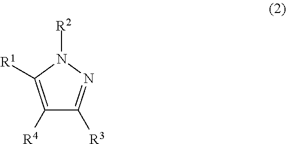

wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; and

R² is a substituted or unsubstituted C₁ to about C₁₆ aliphatic group, a substituted or unsubstituted C₁ to about C₁₆ aryl group, or a combination thereof, optionally bearss a functionality;

optionally any combination of R¹, R², R³ and R⁴ together with the azole ring atoms to which they are bonded, to form a cyclic structure.

In certain embodiments of compounds of formula (2), R² is a substituted or unsubstituted olefin.

Non-limiting examples of compounds of formula (2) include: N-(3-trimethoxysilylpropyl)pyrazole and N-vinylpyrazole, whose structures are illustrated below, respectively:

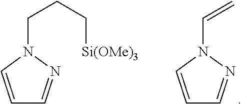

In an embodiment of the invention, the azole is a compound of formula (3) shown below:

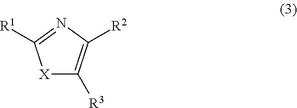

wherein X is a heteroatom that is non-nitrogen, e.g., sulphur, oxygen;

R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality (e.g., substituents may bear a functionality); and

optionally R² and R³, taken together with the azole ring atoms to which they are bonded, form a cyclic structure.

Non-limiting examples of azoles of formula (3) include: oxazole and benzothiazole, whose structures are illustrated below, respectively:

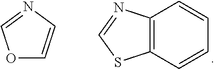

In certain embodiments of the invention, azole is a compound of formula (4), known as a triazole, with three nitrogen atoms at the 1,2,3- or 1,2,4-positions of the heteroaromatic ring, as illustrated below:

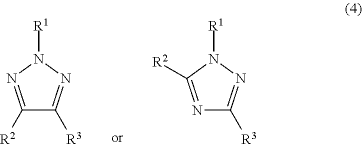

wherein R¹ is a substituted or unsubstituted C₁ to about C₁₆ aliphatic group, a substituted or unsubstituted C₁ to about C₁₆ aryl group, or a combination thereof, and optionally bears a functionality moiety (e.g., substituents may bear a functionality);

R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality moiety (e.g., substituents may bear a functionality);

optionally, any combination of R¹, R², and R³, taken together with the azole ring atoms to which they are bonded, form a cyclic moiety.

In certain embodiments of compounds of formula (4), R¹ is a substituted or unsubstituted olefin.

Non-limiting examples of triazoles of formula (4) include: 1-vinyl-1,2,4-triazole, and 1-methyl-1,2,3-triazole, whose structures are shown below, respectively:

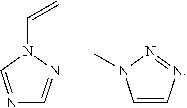

### Fillers

Provision of filler such as carbon black, precipitated silica, talc, clay, glass fibres, polymeric fibres, crystalline organic compounds, finely divided minerals and finely divided inorganic materials can improve the physical properties of polymers. Typically, the amount of filler is between 10 wt % and 60 wt %. Preferably, filler content is between 20 and 45 wt %.

Suitable fillers for use in the present invention comprise particles of a mineral, such as, for example, silica, silicates, clay (such as bentonite), gypsum, alumina, titanium dioxide, talc and the like, as well as mixtures thereof. Further examples of suitable fillers include:
highly dispersable silicas, prepared e.g. by the precipitation of silicate solutions or the flame hydrolysis of silicon halides, with specific surface areas of 5 to 1000, preferably 20 to 400 m²/g (BET specific surface area), and with primary particle sizes of 10 to 400 nm; the silicas can optionally also be present as mixed oxides with other metal oxides such as Al, Mg, Ca, Ba, Zn, Zr and Ti;
synthetic silicates, such as aluminum silicate and alkaline earth metal silicate;
magnesium silicate or calcium silicate, with BET specific surface areas of 20 to 400 m²/g and primary particle diameters of 10 to 400 nm;
natural silicates, such as kaolin and other naturally occurring silica;
natural clays, such as montmorillonite, and their ion-exchanged derivatives such as tetraalkylammonium ion exchanged clays;
glass fibers and glass fiber products (matting, extrudates) or glass microspheres;
metal oxides, such as zinc oxide, calcium oxide, magnesium oxide and aluminum oxide;
metal carbonates, such as magnesium carbonate, calcium carbonate and zinc carbonate;
metal hydroxides, e.g. aluminum hydroxide and magnesium hydroxide, or combinations thereof.

Mineral fillers, as described hereinabove, can also be used alone or in combination with known non-mineral fillers, such as:
carbon blacks; suitable carbon blacks are preferably prepared by the lamp black, furnace black or gas black process and have BET specific surface areas of 20 to 200 m²/g, for example, SAF, ISAF, HAF, FEF or GPF carbon blacks;
nano-crystalline cellulose and its surface modified derivatives;
rubber gels, preferably those based on polybutadiene, butadiene/styrene copolymers, butadiene/acrylonitrile copolymers and polychloroprene.

Provision of nano-scale filler such as exfoliated clay platelets, sub-micron particles of carbon black, and sub-micron particles of siliceous fillers such as silica can improve the physical properties of polymers, in particular the impermeability, stiffness and abrasion resistance of the material. Typically, the amount of nano-scale filler is between 0.5 wt % and 30 wt %. Preferably, nano-scale filler content is from about 2 to about 10 wt %.

In certain embodiments of the invention, fillers, as described hereinabove, are included during the preparation processes of azolium ionomer and cured azolium ionomer. The method of dispersing filler into the uncured formulation is not particularly restricted, and selection of an appropriate mixing device is within the purview of one that is skilled in the art. Typically, the amount of filler added to the uncured formulation ranges from 2-60 percent of the total mixture weight. More preferably, the filler content is between 4 and 35 wt %.

In certain embodiments of the invention, additives known to those skilled in the art of the invention are included in the azolium ionomer preparation process to improve material properties. For example, provision of antioxidants such as phenolics and amines can improve the oxidative stability of the material. Although not wishing to be limited, the inventors suggest that typical antioxidant amounts are 10-1000 ppm. Anti-ozone and UV-stabilizing compounds can be added to improve weathering characteristics. The provision of process aids such as tackifiers, waxes, oils and soaps can improve the processing properties and cost of a polymer formulation.

In other embodiments, polymers that do not contain halogenated electrophiles are included during the mixing step to yield a polymer blend. The resulting blend is formed into the desired shape, and heated to a cure temperature sufficient to bring about cross-linking. The non-electrophilic polymer may remain uncross-linked, such as is commonplace for thermoplastic vulcanizates (TPV), or it may be cross-linked using a formulation that is appropriate for its composition.

In an embodiment, cured and uncured azolium ionomers provide enhanced adhesion. Adhesion of a polymer to solid surfaces is an important physical property that leads to formation of composite materials. However, owing to their low surface energies, most polyolefins exhibit only moderate adhesion to glass, mylar, plastic, mineral, metal and ceramic surfaces and, as a result, have deficiencies when used in composite applications. Introduction of ionic functionality to a polymer composition is expected to improve adhesive properties over its non-ionic parent material, owing to the strength of ion-dipole interactions between ionomers and solid surfaces.

In another embodiment, azolium ionomers (cured and uncured) described herein enhance the properties of a polymer blend. TPVs use mixtures of semi-crystalline polymers and thermoset elastomers to provide compositions with exceptional physical properties. Blends of different elastomers are widely used in rubber articles such as tire treads, where optimization of properties such as abrasion resistance, rolling resistance and traction are critical to performance. Ionomers, as described herein, are cross-linked using reaction conditions similar to those used in existing TPV and elastomer blends, and are therefore expected to be particularly useful in these applications.

In yet another embodiment of the present invention, azolium ionomers (cured and uncured) reduce a population of and/or prevent accumulation of organisms, including bacteria, algae, fungi, mollusks or arthropods. Although not wishing to be bound by theory, the inventors suggest that the ion pairs may impart antimicrobial properties that are not observed in typical halogenated polymers. Microorganism against which a thermoset azolium ionomer is expected to be effective include, for example: Gram-negative bacteria—Salmonella, Shigella, Neisseria gonorrhoeae, Neisseria meningitidis, Haemophilus influenzae, Escherichia coli, Klebsiella, Pseudomonas aeruginosa. Gram-positive bacteria—Bacillus, Listeria, Staphylococcus, Streptococcus, Enterococcus, Clostridium, Epulopiscium, Sarcina, Mycoplasma, Spiroplasma, Ureaplasma, Lactobacillus, Corynebacterium, Propionibacterium, Gardnerella, Frankia, Streptomyces, Actinomyces, and Nocardia. Algae: Chlorophyta, Rhodophyta, Glaucophyta, Chlorarachniophytes, Euglenids, Heterokonts, Haptophyta, Cryptomonads, Dinoflagellates. Fungi: Alternaria, Aspergillus, Basidiomycetes, Botrytis, Candida albicans, Cephalosporium, Cheatomium, Cladosporium, Cuvalaria, Drechslera, Epicoccum, Fusarium, Geotrichum, Helminthosporium, Humicola, Monilia, Neuspoa, Nigrospora, Penicillium, Phoma, Pullularia, Rhizophus, Rhodotorula, Scopulariopsis, Stemphylium, Trichoderma, Unocladium and Verticillum.

In an embodiment of the invention, the ionomer may be formed into a shaped article or applied to an existing article. The article may be made entirely from the ionomer. Alternatively, a portion of the article may comprise the ionomer. The ionomer may be provided on the surface of the article only. The ionomer may be provided as part of a composite material. The composite material may comprise plastic, wood, and/or natural fibre, (e.g., carbon, glass fibres).

Accordingly, articles made from azolium ionomers (cured and uncured) such as, for example, caulking, contact cements, pressure sensitive adhesives, tank liners, membranes, o-rings, tire inner liners, tire treads, TPVs, gaskets, and sealants, can benefit from these qualities. Azolium ionomers (cured and uncured) may also find use in applications such as, for example, consumer applications, industrial and medical products and include but are not limited to the following: appliances, baby products, bathroom fixtures, bathroom safety, flooring, food preparation and storage, garden, kitchen fixtures, kitchen products, office products, pet products, sealants and grouts, spas, water filtration and storage equipment, food preparation surfaces and equipment, shopping carts, surface applications, storage containers, footwear, protective wear, sporting gear, carts, dental equipment, door knobs, clothing, telephones, toys, catherized fluids in hospitals, surfaces of vessels and pipes, coatings, food processing, biomedical devices, filters, additives, computers, ship hulls, shower walls, articles to minimize the problems of biofouling, pacemakers, implants, wound dressing, medical textiles, ice machines, water coolers, fruit juice dispensers, soft drink machines, piping, storage vessels, metering systems, valves, fittings, attachments, filter housings, linings, barrier coatings, and chemical/biochemical protective equipment.

### Method of Ionomer Preparation

An aspect of the invention provides a method of making stable, curable but not yet cured, azolium ionomers. In certain embodiments, halogenated polymers and at least one azole are mixed to form a mixture. Optionally, the mixture can comprise other additives (e.g., filler) as described herein. This preparation method can be conducted both in the absence or in the presence of solvent.

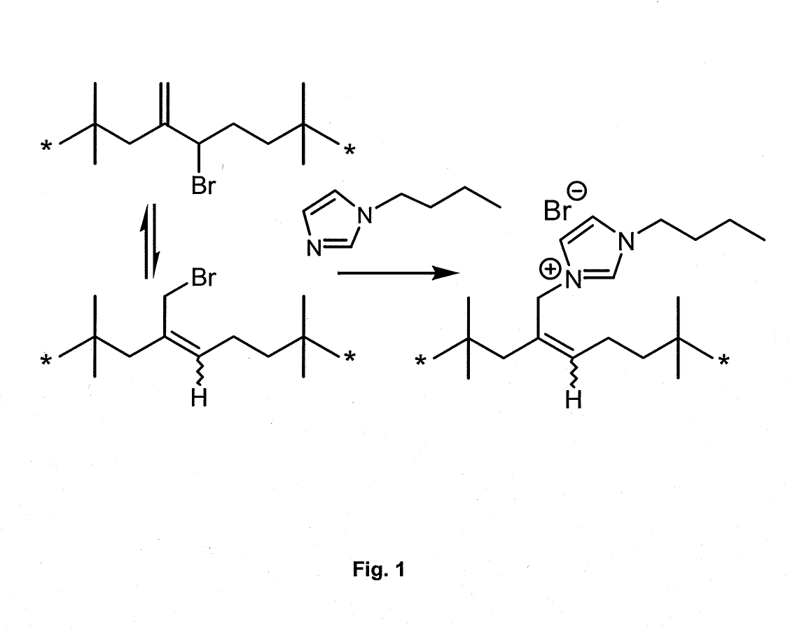

In the absence of solvent, mixing is performed using standard polymer processing equipment (e.g., internal mixer, a two-roll mill, an extruder, or the like). Nucleophilic substitution by azole of halide from the halogenated polymer proceeds irreversibly to give an ionomer comprising azolium halide ion pairs. FIG. 1 illustrates the N-alkylation of an example azole, specifically a compound of formula (1), N-butyl imidazole, by an allylic bromide functionality within BIIR to yield an azolium halide ionomer, specifically, N-butyl imidazolium bromide ionomer. Note that non-electrophilic mers within BIIR that are unreactive toward azoles have been omitted from FIG. 1 for clarity. The reaction rate is dependent on temperature, and the process is generally carried out from about 60° C. to about 180° C., more preferably from about 90° C. to about 160° C.

Solvent-free azolium ionomer preparations can be carried out to obtain various conversion amounts converting azole and halogenated electrophile to azolium salts. The amount of conversion of azoles to azolium salts is preferably maximized, such that isolation of residual azole from the product is not required. If residual azole remains in the ionomer product, it may be left in the material or removed by heating, placing under vacuum, or heating and placing under vacuum. Amount of conversion of halogenated electrophile to azolium salt may be selected based on the desired azolium ionomer composition. Where ion pair concentrations are to be maximized, desired halogenated electrophile conversion is 100%. However, if residual halogenated electrophile is desired within the azolium ionomer, this conversion can be reduced. Such residual may be desired, for example, if halogenated electrophile is needed in the azolium ionomer for other reactions such as vulcanization.

In the presence of solvent, halogenated polymers, one or more azoles, and optionally, other additives, are mixed in the presence of a solvent that is suitable for dissolving the halogenated polymer. The selection of such a solvent is not particularly restricted, and the choice thereof for use in this process is within the purview of a person skilled in the art. Non-limiting examples of suitable solvents include toluene, hexane, tetrahydrofuran, xylene and mixtures thereof. The rate of these solvent-borne reactions is dependent on temperature, and these processes are typically carried out from about 60° C. to about 160° C. If the desired temperature is above the boiling point of the solvent, then the reaction is conducted at a pressure that is sufficient to maintain the polymer mixture in a liquid state using a suitably equipped pressure vessel. As described hereinabove for the solvent-free method, azole and halogenated electrophile conversions can be independently controlled to provide a desired azolium ionomer product composition. Recovery of product from solution is possible by addition of ionomer product solution to a solvent that does not dissolve the product, thereby leading to precipitation of azolium ionomer from solution. Alternatively, ionomer product cement can be subjected to steam stripping to remove solvent, leaving a crumb that can be dried using conventional methods.

### Anion Exchange

In certain embodiments of the present invention, the halide anion of the azolium ionomer is exchanged with a different anion or a mixture of anions. Anion exchange, commonly called anion metathesis, is generally done to improve the stability of an ion pair by replacing a nucleophilic anion with a less reactive anion. In the context of azolium ionomers, this is not necessary, since azole alkylation is effectively irreversible. Nevertheless, it can be desirable to exchange halide with a different anion in order to change the properties of an azolium ionomer. For example, exchanging halide for an anionic moiety that comprises two anionic groups can affect the mechanical properties of the ionomer. Introducing an anion that bears reactive functionality can facilitate a wide range of chemical reactivity to an azolium ionomer.

In certain embodiments, anion exchange is carried out under solvent free conditions by mixing azolium ionomer with a salt comprising the desired anion for exchange using standard polymer processing equipment such as an internal mixer, a two-roll mill, an extruder, and the like. In this case, after reaction, the exchanged azolium ionomer will comprise a mixture of the original halide anion and the desired (exchanged) anion. In other embodiments, exchange is carried out in a solvent that dissolves the azolium ionomer. A salt of the desired anion is added to this solution in sufficient concentration to promote anion exchange. In another embodiment, solvent is selected so that halide precipitates from solution as a salt, leaving ion pairs comprising azolium cation and a desired (exchanged) anionic moiety.

Choice of anionic moiety for anion exchange with an azolium ionomer is not particularly restricted and is within the purview of one skilled in the art. In certain embodiments of the invention, the anionic moiety is a carboxylate of formula (5) shown below:

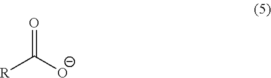

where R is a substituted or unsubstituted C₁ to about C₁₆ aliphatic group, a substituted or unsubstituted C₁ to about C₁₂ aryl group, or a combinations thereof, wherein substituents may bear a functionality.

In certain embodiments of the invention, the anionic moiety is a sulfate of formula (6a):

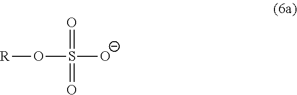

where R¹ is a substituted or unsubstituted C₁ to about C₁₆ aliphatic group, or a substituted or unsubstituted C₁ to about C₁₂ aryl group, or a combination thereof, wherein substituents may bear a functionality.

In certain embodiments of the invention, the anionic moiety is a sulfonate of formula (6b):

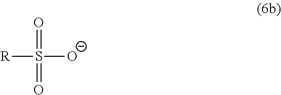

where R¹ is a substituted or unsubstituted C₁ to about C₁₆ aliphatic group, or a substituted or unsubstituted C₁ to about C₁₂ aryl group, wherein substituents may bear a functionality.

In certain embodiments of the invention, the anionic moiety is a borate of formula (7):

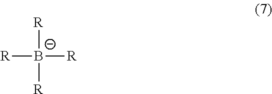

where R is independently: fluorine, a substituted or unsubstituted C₁ to about C₁₆ aliphatic group, a substituted or unsubstituted C₁ to about C₁₂ aryl group, or a combination thereof, wherein substituents may bear a functionality.

In certain embodiments of the invention, the anionic moiety is a phosphate of formula (8):

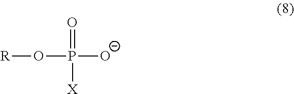

where X is O⁻ or OR¹, R and R¹ are a substituted or unsubstituted C₁ to about C₁₆ aliphatic group, a substituted or unsubstituted C₁ to about C₁₂ aryl group, or a combination thereof, wherein substituents may bear a functionality.

In certain embodiments of the invention, the anionic moiety is a phosphonate of formula (9a):

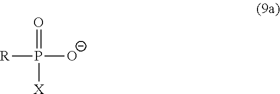

where X is O⁻ or OR¹, R and R¹ are a substituted or unsubstituted C₁ to about C₁₆ aliphatic group, a substituted or unsubstituted C₁ to about C₁₂ aryl group, or a combination thereof, wherein substituents may bear a functionality.

In certain embodiments of the invention, the anionic moiety is a phosphinate of formula (9b):

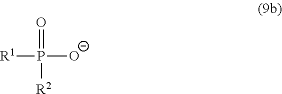

where R¹ and R² are a substituted or unsubstituted C₁ to about C₁₆ aliphatic group, a substituted or unsubstituted C₁ to about C₁₂ aryl group, or a combination thereof, wherein substituents may bear a functionality.

In certain embodiments of the invention, the anionic moiety has two anionic groups, each selected independently from carboxylate, sulfate, sulfonate, borate, phosphate, phosphonate or phosphinate. Non-limiting examples include persulfate, bis(dimethylallyl)pyrophosphate, etidronate, and the conjugate base of adipic acid, as illustrated below, respectively.

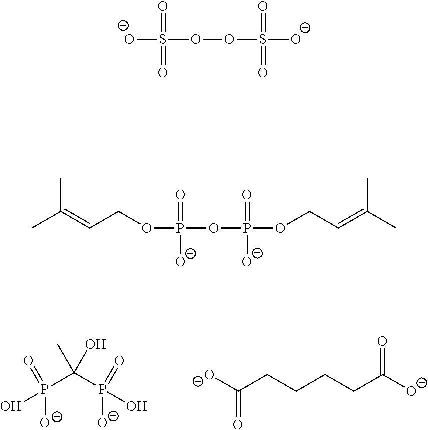

### Amount of Azole

Given that ionomer synthesis involves nucleophilic displacement of halogen from the halogenated polymer, an amount of azole used relative to amount of halogen affects the extent of polymer functionalization. Typically, the molar ratio of azole to halogen is from about 0.1:1 to about 3.0:1. More preferably, the molar ratio of azole to halogen is from about 0.7:1 to about 1.5:1.

### Azolium Ionomers

An aspect of the present invention provides an azolium ionomer comprising a polymer backbone, a plurality of covalently-bound, pendant azolium cations, and a plurality of anions associated with azolium cations to form ion pairs with a general formula 11:

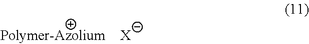

where “Azolium⁺” represents a polymer-bound azolium cation, “X⁻” represents an anion associated with the azolium cation, and “Polymer” is a macromolecule to which the azolium cation is covalently attached. As those with skill in the art of the invention will recognize, an azolium ionomer may have many pendant groups attached. Accordingly, for clarity in the discussion herein, a singular pendant group may be described to represent a plurality of pendant cations and associated anions.

Anions associated with azolium cations, depicted as X⁻ in formula (11), are not particularly restricted, and comprise one or more anions of formulas (5), (6a), (6b), (7), (8), (9a), (9b), (10) and the corresponding di-anions described hereinabove, and may bear functionality.

The macromolecule to which the azolium cation is bound, depicted as “Polymer” in formula (11), is not particularly restricted, and can comprise any polymerized olefin monomer and halogenated electrophile, as defined hereinabove, and may bear functionality. In a preferred embodiment, the macromolecule comprises a random distribution of isobutylene mers, isoprene mers and residual allylic halide electrophiles. Non-limiting examples of macromolecule include those derived from the N-alkylation of azoles by BIIR and CIIR.

In another preferred embodiment, the macromolecular substitutent comprises a random distribution of isobutylene mers, para-methylstyrene mers and residual benzylic halide electrophiles. A non-limiting example of this macromolecular substituent includes that derived from the N-alkylation of azoles by BIMS.

In another preferred embodiment, the macromolecular substitutent comprises a random distribution of 2-chloro-1,3-butadiene mers and allylic halide electrophiles. A non-limiting example of this macromolecular substituent includes that derived from the N-alkylation of azoles by polychloroprene.

In another preferred embodiment, the macromolecular substitutent comprises a random distribution of ethylene mers, propylene mers and halogen electrophiles. Non-limiting examples of this macromolecular substituent include those derived from the N-alkylation of azoles by halogenated poly(ethylene-co-propylene) copolymers and halogenated poly(ethylene-co-propylene-co-ethylidene norbornadiene) terpolymers.

In another preferred embodiment, the macromolecular substitutent comprises a random distribution of propylene mers and residual alkyl halide electrophiles. A non-limiting example of this macromolecular substituent includes that derived from the N-alkylation of azoles by halogenated polypropylene.

In another preferred embodiment, the macromolecular substitutent comprises a random distribution of ethylene mers and residual alkyl halide electrophiles. A non-limiting example of this macromolecular substituent includes that derived from the N-alkylation of azoles by halogenated polyethylene.

In certain embodiments, polymer-bound azolium cations, depicted as “Azolium⁺” in formula 11, are derived from one or more of imidazoles, pyrazoles, thiazoles, oxazoles and triazoles, as described hereinabove. These azolium cations are covalently bound by N-alkylation of the corresponding azoles. For example, the azolium cation illustrated in FIG. 1 is covalently bound by N-alkylation at position 3 of the of 1-butyl-imidazole ring.

In a preferred embodiment of the invention, the azolium ion is a compound of formula (12) shown below which includes an imidazolium cation:

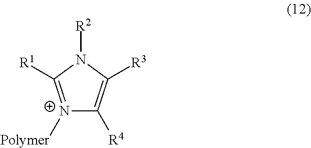

where R¹ is hydrogen, silane, a substituted or unsubstituted C₁ to about C₁₆ alkyl, or a substituted or unsubstituted C₁ to about C₁₂ aryl group, wherein substituents may bear a functionality;

R² is a substituted or unsubstituted olefin, a substituted or unsubstituted C₁ to about C₁₆ alkyl, or a substituted or unsubstituted C₁ to about C₁₂ aryl group, wherein substituents may bear a functionality;

R³ and R⁴ are independently hydrogen, silane, a substituted or unsubstituted C₁ to about C₁₆ alkyl, or a substituted or unsubstituted C₁ to about C₁₆ aryl group, wherein substituents may bear a functionality;

R³ and R⁴ can be independent or together with the C═C unit to which they are attached, to form a cyclic structure; and

“Polymer” is a macromolecule covalently bonded to the imidazolium ion.

Non-limiting examples of compounds of formula (12) include: 1-decyl-2-methyl-3-alkylimidazolium, 1-(2-hydroxyethyl)-3-alkyl imidazolium, and 1-butyl-3-alkyl-benzimidazole whose structures are illustrated below, respectively:

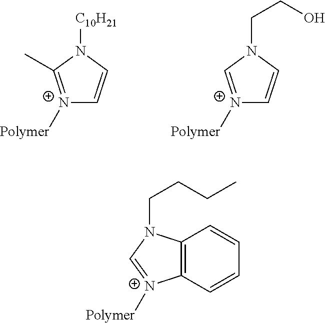

where “Polymer” is a macromolecule covalently bonded to the imidazolium ion.

In an embodiment of the invention, the azolium ion is a compound of formula (13) shown below which includes a pyrazolium cation:

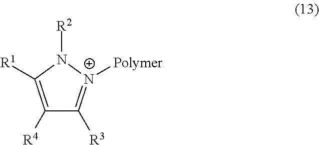

wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, wherein substituents may bear a functionality; and

R² is, a substituted or unsubstituted C₁ to about C₁₆ aliphatic group, a substituted or unsubstituted C₁ to about C₁₂ aryl group, or a combination thereof, wherein substituents optionally bears a functionality;

wherein optionally any combination of R¹, R², R³ and R⁴ together with the azole ring atoms to which they are bonded, to form a cyclic structure; and

“Polymer” is a macromolecule covalently bonded to the pyrazolium ion.

In an embodiment of the invention, the azolium cation is a compound of formula (14) shown below:

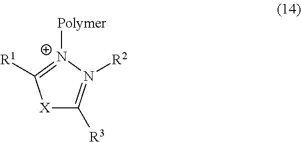

wherein X is a heteroatom that is non-nitrogen, e.g., sulphur, oxygen;
R¹, R² and R³ are independently hydrogen, silane, a substituted or unsubstituted C₁ to about C₁₆ aliphatic group, a substituted or unsubstituted C₁ to about C₁₆ aryl group, or a combination thereof, wherein substituents may bear a functionality; and
wherein optionally R² and R³ taken together with the azole ring atoms to which they are bonded form a cyclic structure; and
“Polymer” is a macromolecule covalently bonded to the azolium ion.

In certain embodiments of the invention, azolium ion is a compound of formula (15), known as a triazole, with three nitrogen atoms at the 1,2,3- or 1,2,4-positions of the heteroaromatic ring, as illustrated below:

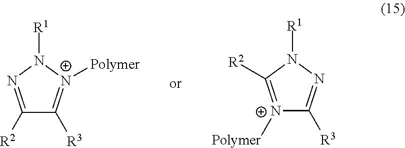

where R¹ is a substituted or unsubstituted C₁ to about C₁₆ aliphatic group, a substituted or unsubstituted C₁ to about C₁₂ aryl group, or a combination thereof, wherein substituents may bear a functionality; and
R² and R³ are independently hydrogen, silane, a substituted or unsubstituted C₁ to about C₁₆ aliphatic group, a substituted or unsubstituted C₁ to about C₁₂ aryl group, or a combination thereof, wherein substituents may bear a functionality;

optionally, any combination of R¹, R², and/or R³ taken together with the azole ring atoms to which they are bonded form a cyclic moiety; and

“Polymer” is a macromolecule covalently bonded to the triazolium ion.

### Azolium Ionomers Capable of Moisture Curing

In a preferred embodiment, azolium cations bear moisture-curing functionality. Note that a polymer backbone comprising olefin and diolefin monomers lacks the silane functionality required to engage the hydrolysis and condensation reactions that make up a moisture-curing process. As such, these materials cannot be used where moisture-curing technology is desired, such as in certain adhesive, sealant and wire coating applications. Furthermore, these materials cannot form covalent bonds with siliceous fillers such as precipitated silica. However, an azolium ionomer comprising such a polymer backbone and pendant azolium cations that bear silane functionality can be moisture-cured to a high cross-link density, and they can react with siliceous surfaces and fillers to form covalent bonds.

Silane-bearing azolium cations may comprise polymer-bound imidazolium, pyrazolium, oxazolium, thiazolium and triazolium cations, or mixtures thereof, and include silane functionality with a formula 13:

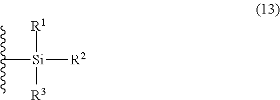

where R¹=hydrogen, halogen, alkyl ether, aryl ether, allyl ether; R² and R³ are independently hydrogen, halogen, alkyl ether, aryl ether, allyl ether, alkyl, aryl, vinyl or allyl. A non-limiting example of an azolium ion that is capable of supporting a moisture cure is 1-(3-trimethoxysilylpropyl)-3-alkyl-imidazolium, illustrated with a bromide anion:

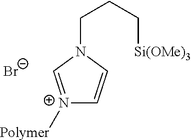

where “Polymer” is a macromolecule bonded to the azolium ion. A plurality of this azolium bromide ion pair supports moisture curing through hydrolysis and condensation reactions of —SKOMe)₃ functionality.

Since a moisture-curing azolium ionomer is cross-linked through reactions between silane functionality, the number of silane groups per polymer chain will affect the extent of polymer cross-linking that can be achieved. Typically, the average silane functionality content is from about 0.1 to about 100 pendant groups per 1000 polymer backbone carbons. More preferably, the average functional group content is between 5 and 50 pendant groups per 1000 polymer backbone carbons. It will be understood by those skilled in the art that reference to average silane functionality content refers to a population of polymer molecules and not necessarily to a single or particular polymer molecule.

### Azolium Ionomers Capable of Radical Curing

In a preferred embodiment, azolium ions bear functionality that engages in free radical oligomerization. Many polymers cannot be cross-linked when subjected to a free radical generating technique, these include propylene-rich materials and IIR comprising less than 3 mole % of isoprene. However, an azolium ionomer bearing free radical oligomerizing functionality can be cross-linked when subjected to a radical generating technique. Suitable azolium cations include imidazolium, pyrazolium, oxazolium, thiazolium and triazolium cations, or mixtures thereof, bearing C═C functionality that oligomerizes when subjected to a radical generating technique. Free radical oligomerizable functionality is not particularly restricted, and may include styrenic, acrylate, olefin, diene, vinyl, maleate, itaconate, and cinnamate moieties, and mixtures thereof.

In a preferred embodiment, the oligomerizable functionality comprises a vinyl group. A non-limiting example of an azolium cation that bears an oligomerizable vinyl group is 1-vinyl-3-alkyl-imidazolium chloride:

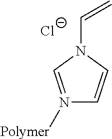

An non-limiting example of an azolium ionomer capable of radical curing, comprises BIIR-derived backbone and 1-vinyl-3-allyl-imidazolium bromide ion pairs:

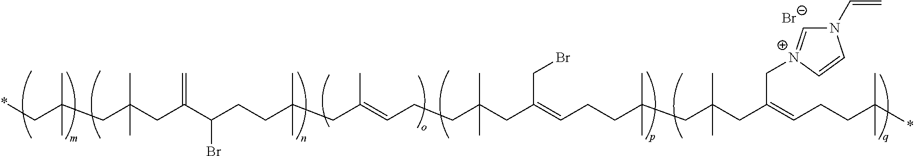

where a plurality of —CH═CH₂ functionality supports a free radical cure. A further non-limiting example comprises a polypropylene-derived backbone and 1-vinyl-2-alkyl-pyrazolium bromide ion pairs:

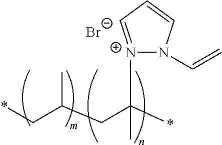

where a plurality of —CH═CH₂ functionality supports a free radical cure.

In another preferred embodiment, the oligomerizable functionality comprises a methacrylate group. A non-limiting example of an azolium cation that bears a methacrylate moiety is:

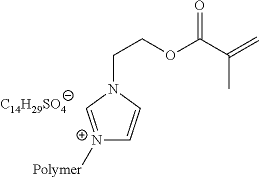

where “Polymer” is a macromolecule covalently bonded to the azolium ion. A plurality of azolium sulphate ion pairs support free radical curing by oligomerization of their respective —O—CO—CMe═CH₂ functionalities. Another non-limiting example of an azolium ionomer that bears oligomerizable methacrylate groups comprises a BIMS-derived backbone and 1-(2-ethylmethacrylate)-3-benzyl-imidazolium bromide ion pairs:

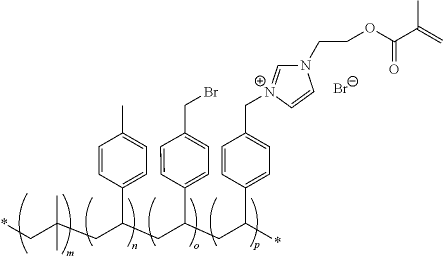

where a plurality of —O—CO—CMe═CH₂ functionality supports a free radical cure.

Since a free radical curing azolium ionomer is cross-linked through reactions between oligomerizable functionality, the number of oligomerizable groups per polymer chain will affect the extent of polymer cross-linking that can be achieved. Typically, the average free radical oligomerizable functionality content is from about 0.1 to about 100 pendant groups per 1000 polymer backbone carbons. More preferably, the average functional group content is between 5 and 50 pendant groups per 1000 polymer backbone carbons. It will be understood by those skilled in the art that reference to average functionality content refers to a population of polymer molecules and not necessarily to a single or particular polymer molecule.

It is common practice for polymers to be mixed with other additives to improve the physical properties, the chemical properties, and the cost of the material. These other additives can include, but are not restricted to, reinforcing fillers, non-reinforcing fillers, processing aids, antioxidants, ultraviolet radiation stabilizers, waxes, oils and the like.

In certain embodiments of the invention, azolium ionomers comprise additives that improve the physical and chemical properties of the material.

### Crosslinking of Azolium Ionomers

Amorphous polymers that are used above their glass transition temperatures are rubbery, and will flow extensively under an applied stress unless they are cross-linked into a polymer network. Therefore, in most fields of use, rubbery azolium ionomers described herein are cross-linked to yield articles that resist creep, stress relaxation and compression set. Furthermore, it is often desirable to cross-link semi-crystalline polymers to generate thermoset materials with improved high-temperature creep and stress relaxation properties. Formulations used to cross-link the backbone of azolium ionomers are not particularly restricted, and can be selected by one who is skilled in the art of polymer compounding and curing. For example, an azolium ionomer with a backbone comprising isobutylene mers and isoprene mers can be cured using formulations that are appropriate to butyl rubber, including high isoprene grades comprising more than 3 mole % of isoprene. Moreover, an azolium ionomer derived from BIIR, BIMS, polychloroprene or halogenated polypropylene having residual halogen electrophile may be cured with recipes that are known to be effective for cross-linking a halogenated polymer backbone.

Importantly, an aspect of the present invention provides a method of cross-linking other than the backbone of an azolium ionomer, that is, cross-linking of azolium ionomers by activating functional moieties located on azolium ion pairs, which are covalently-bound to the backbone in a pendant position.

### Moisture Curing Certain Azolium Ionomers

In an embodiment of the invention, such non-backbone cross-linking is achieved by moisture-curing azolium ionomers comprising silane functionality. The method of cross-linking a moisture-curing azolium ionomer involves mixing the ionomer, optionally other additives, and moisture-curing formulation components to form a mixture. These moisture-curing formulation components are not particularly restricted, and are within the purview of those skilled in the art. Examples of moisture-curing formulation components are described below. The resulting mixture is formed to the desired shape using standard polymer processing equipment, and cured by activating alkoxysilane groups by the application of a trigger. In some embodiments the trigger is heat, moisture, or heat and moisture.

Moisture-curing formulation components include known Lewis acid catalysts and moisture generating components. A moisture-generating component is one that liberates water when subjected to sufficient heat. Examples of moisture-generating components include: a hydrated compound, aluminum trihydroxide (ATH), a mixture of metal oxide and a carboxylic acid, or any combination thereof. In further embodiments, the hydrated compound comprises CaSO₄.2H₂O (gypsum), MgSO₄.7H₂O, or a combination thereof. In certain embodiments, the mixture of a metal oxide and a carboxylic acid comprises ZnO and stearic acid.

The term “moisture” means an amount of water sufficient to initiate and sustain such crosslinking reactions. Moisture may be provided from a number of sources and providing moisture includes adding actual water, adding an unreactive compound that includes water, adding components that liberate water through reaction, heat, etc. In some embodiments, the halogenated elastomers are sufficiently wet to act as both the halogenated elastomer and the moisture-generating component since some halogenated elastomers include water when they are received from the manufacturer. In these cases, rigorous exclusion of water from the azolium ionomer and/or while mixing halogenated polymer+azole formulation is necessary to ensure that crosslinking does not occur during the mixing process or during storage.

In some cases, moisture can be provided merely by passively exposing the mixture to a humid atmosphere; this type of formulation could be used, for example, in moisture-curing sealant applications. In such applications, a user applies a sealant to a surface and exposure to natural humidity in the atmosphere is sufficient to activate crosslinking reactions. As described herein in such applications, substituents bearing a functionality may include antibacterial and/or antifungal properties.

### Radical Curing of Certain Azolium Ionomers

In another embodiment, cross-linking is achieved for azolium ionomers comprising free-radical oligomerizable functional moieties, such ionomers are known herein as “free-radical curing azolium ionomers”. The method of cross-linking a free radical-curing azolium ionomer involves exposing the ionomer to an appropriate trigger. As the name implies, the trigger for free-radical curing azolium ionomers is the presence of free-radicals. Accordingly, crosslinking is initiated by subjecting the free-radical curing azolium ionomers to a radical generating technique.

In certain embodiments of free-radical curing azolium ionomers, the curing method comprises mixing the free radical-curing azolium ionomer and a radical initiating component to form a mixture. Optionally, the mixture may further comprise other additives as described herein. Radical-initiating components are not particularly restricted, and suitable cure formulations can be developed by those skilled in the art. The resulting mixture is formed to the required shape using standard polymer processing equipment, and cured by activating the radical initiating components thermally and/or photolytically.

Free-radicals may be generated, for example, through the use of ultraviolet light, a chemical initiator (e.g., organic peroxide, inorganic peroxide), thermo-mechanical means, radiation, electron bombardment and the like. See any of the following references for a general discussion on radical generation techniques: Moad, G. Prog. Polym. Sci. 1999, 24, 81-142; Russell, K. E. Prog. Polym. Sci. 2002, 27, 1007-1038; and Lazar, M., Adv. Polym. Sci. 1989, 5, 149-223. When an organic peroxide is used, the organic peroxide is generally present in an amount from about 0.005 wt % to about 5.0 wt %, more preferably, from about 0.05 wt % to about 1.0 wt %.

In a further embodiment of the invention, an azolium ionomer is mixed with a co-agent prior to subjecting the compound to a radical generating technique. If the amount of oligomerizable C═C functionality in an azolium ionomer is insufficient to provide the desired extent of crosslinking, then additional cross-linking can be gained by curing a mixture comprising the azolium ionomer and a small amount of co-agent comprising oligomerizable C═C bonds. Typically, co-agent content of these mixtures is from about 0.1 wt % to about 10 wt %. In certain embodiments, the co-agent content is between 0.5 wt % and 2 wt %. Non-limiting examples of co-agents include trimethylolpropane triacrylate, triallyl trimellitate, N,N′-m-phenylenedimaleimide, and 1-vinyl-3-decyl-imidazolium bromide, whose structures are illustrated below, respectively.

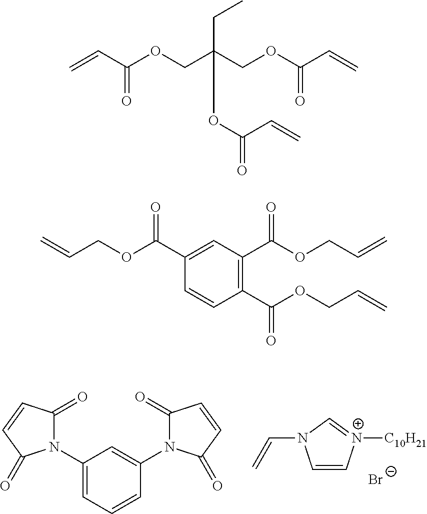

### Cured Azolium Ionomers

An aspect of the present invention includes a cured product of the method for cross-linking azolium ionomers described hereinabove. Techniques for curing azolium ionomers include moisture curing and radical curing. These cross-linked products are expected to have superior qualities such as thermo-oxidative stability, exceptional compression set resistance, high modulus, and excellent gas impermeability, antimicrobial activity and excellent adhesion properties. Accordingly, articles made from such crosslinked ionomers such as, for example, fuel cell membrane, pharmaceutical stopper, syringe fitting, ion-exchange resin, separation membrane, bathroom safety equipment, garden equipment, spa equipment, water filtration equipment, caulking, sealant, grout, contact cement, adhesive, pressure sensitive adhesive, tank liner, membrane, packaging material, cell culture equipment, light switch, exercise equipment, railing, sports equipment, steering wheel, writing tool, luggage, o-ring, tire inner liner, tire tread, thermoplastic vulcanizate (TPV), gasket, appliance, baby product, bottle, lid, toilet seat, bathroom fixture, flooring, surface including surface for food preparation, utensil, handle, grip, doorknob, container for food storage, gardening tool, kitchen fixture, kitchen product, office product, pet product, water storage equipment, food preparation equipment, shopping cart, surfacing material, storage container including food storage container, footwear, protective wear, sporting gear, cart, dental equipment, door knob, clothing, handheld device, telephone, toy, container for fluid, catheter, keyboard, surface of vessel, surface of pipe, surface of duct, coating, food processing equipment, materials handling equipment (e.g., auger, conveyor belt), biomedical device, filter, additive, computer, dock, drilling platform, ship hull, underwater infrastructure, HVAC equipment, shower wall, shower flooring, implant, medical textile, tissue sealant, tissue adhesive, personal protective equipment, wetsuit, drysuit, respiratory mask, article to minimize biofouling, pacemaker, wound dressing, ice machine, water cooler, fruit juice dispenser, soft drink machine, piping, storage vessel, metering system, valve, fitting, attachment, filter housing, lining, barrier coating, insulation, chemical protective equipment, or biochemical protective equipment, can benefit from these qualities.

In one embodiment, the cured azolium ionomers according to the present invention provide enhanced mechanical properties. Thermoset materials comprising stable covalent bonds are known to resist deformation and stress relaxation when exposed to static loads, but often respond poorly to dynamic loads. Cured azolium ionomers, as described herein, have polymer chain networks comprising covalent bonds and labile ion-pair aggregates. This combination may provide good static properties such as compression set, good dynamic properties such as fatigue to failure, or both. Thus, a cured azolium ionomer may provide a unique balance of both static properties such as compression set and dynamic properties such as flex fatigue.

In an embodiment, a cured azolium ionomer according to the present invention possesses superior properties compared to non-ionic thermosets, e.g., sulfur-cured, peroxide-cured or resin-cured polymers. For example, a cured azolium ionomer according to the present invention may provide superior adhesion, superior antimicrobial activity, and/or superior mechanical properties, compared to non-ionic thermosets (e.g., sulfur-cured, peroxide-cured or resin-cured). In a particular embodiment, a cured azolium ionomer according to the present invention provides both superior static properties such as compression set and superior dynamic properties such as flex fatigue, compared to non-ionic thermosets. In another embodiment, a cured azolium ionomer provides superior flex fatigue, Young's modulus and/or tensile strength, compared to non-ionic thermosets.

### Kits

Aspects of the present invention may be supplied as a kit. In an embodiment of this aspect, the kit includes haloelastomer and an azole that has moisture curing functionality, and is provided as a mixture that is stored in a single container; there should be substantially no water in the mixture. The single container should be such that the integrity of its contents is preserved. The user of the kit would then apply the mixture to a surface (or form a desired shape) and add moisture. As described above, adding moisture may include passively allowing a humid atmosphere to be in contact with the mixture.

In another embodiment of this aspect, the kit includes haloelastomer and azole that are stored in two separate containers. One of the two containers stores haloelastomer and the second container stores azole. Optionally, the haloelastomer can include water (e.g., wet haloelastomer). In certain embodiments the azole bears moisture curing functionality, in such cases, if water is included in the haloelastomer, then the user merely mixes the two components together and the mixture cures due to the presence of water from the haloelastomer being in contact with moisture curing azolium ionomer. If the haloelastomer container does not include water, but instead houses dry haloelastomer, then for azoles that are moisture curable, the user would mix the two components, apply to a surface (or form a desired shape) and add moisture. As described above, adding moisture may include passively allowing a humid atmosphere to be in contact with the mixture.

In another embodiment of this aspect, the kit includes haloelastomer, azoles that are moisture curable, and moisture-generating component. If there is substantially no water included then the mixture may be conveniently provided in a single container. Alternatively, the kit components may be provided in separate containers, keeping in mind that the moisture-generating component could be housed with the haloelastomer at any temperature and it could be housed with the moisture curable azole at temperature below that which causes liberation of water from the moisture-generating component. In a kit which includes the moisture-generating component, the user applies a mixture of the three components to a surface (or form a desired shape) and heats it to a sufficient temperature to liberate moisture from the moisture-generating component.

In an embodiment of this aspect, the kit comprises haloelastomer and an azole that has radical curing functionality. A container(s) for the components should be such that the integrity of its contents is preserved. The user of the kit would then apply the mixture to a surface (or form a desired shape) and add a free radical source (e.g., UV light). As described herein, mixing an azole having radical curing functionality, halogenated polymer in the presence of a radical generating component provides a controllable method for initiating crosslinking reactions. For example, sufficient heat initiates radicals in such mixtures. The user of the kit would then apply the mixture to a surface (or form a desired shape) and add heat.

For example, suitable containers include simple bottles that may be fabricated from glass, organic polymers such as polycarbonate, polystyrene, etc., ceramic, metal or any other material typically employed to hold reagents or food that may include foil-lined interiors, such as aluminum foil or an alloy. Other containers include vials, flasks, and syringes. The containers may have two compartments that are separated by a readily removable membrane that upon removal permits the components to mix. Removable membranes may be glass, plastic, rubber, or the like.

Optionally, kits may also include a molded container to house the mixture during the curing process. Such molds may facilitate preparation of cured polymer in convenient or custom shapes. Kits may also include instruction materials. Instructions may be printed on paper or other substrates, and/or may be supplied as an electronic-readable medium, such as a floppy disc, CD-ROM, DVD-ROM, Zip disc, videotape, audio tape, etc. Detailed instructions may not be physically associated with the kit; instead, a user may be directed to an Internet web site specified by the manufacturer or distributor of the kit, or supplied as electronic mail.

The following working examples further illustrate the present invention and are not intended to be limiting in any respect.

### WORKING EXAMPLES

### Materials and Methods

N-butylimidazole, N-vinylimidazole (99+%), dodecyl bromide, tetrabutyl ammonium acetate, and dicumyl peroxide (98%) were used as received from Sigma Aldrich (Oakville, Ontario, Canada). BIIR (LANXESS Bromobutyl 2030, allylic bromide content=0.2 mmol·g⁻¹) was used as manufactured by LANXESS Inc. (Sarnia, Ontario, Canada). BIMS (benzylic bromide content=0.21 mmol·g⁻¹) was used as manufactured by Exxon Mobil (Houston, Tex., USA). Montmorillonite clay and dicumyl peroxide (98%) were used, as received from Sigma Aldrich. The montmorillonite clay (NR₄⁺-MM, Nanomer® I. 44P) included 35-45 wt % of dimethyldialkylamonium (70% C₁₈, 26% C₁₆, 4% C₁₄) functionality, and was used as received from Sigma-Aldrich. Synthetic hydrated amorphous precipitated silica (HiSil 233) was used, as supplied, by PPG Industries Inc. (Pittsburgh, Pa., USA). Carbon black (Vulcan 3) was used as supplied by Akrochem (Akron, Ohio, USA).

Nuclear Magnetic Resonance (NMR) spectra were recorded with a Bruker Advance-600 spectrometer (600.17 MHz ¹H, 150.92 MHz ¹³C) (Bruker, Milton, Ontario, Canada) in deuterated chloroform (CDCl₃) with chemical shifts referenced to tetramethylsilane. The extent of crosslinking as a function of time was monitored through measurements of dynamic shear modulus (G′) using an Advanced Polymer Analyzer 2000 (APA rheometer, Alpha Technologies, Akron, Ohio, USA) operating at an oscillation frequency of 1 Hz and an arc of 3°.

### Example 1

### Solvent-Free Preparation of Azolium Ionomer, IIR-g-BuImBr

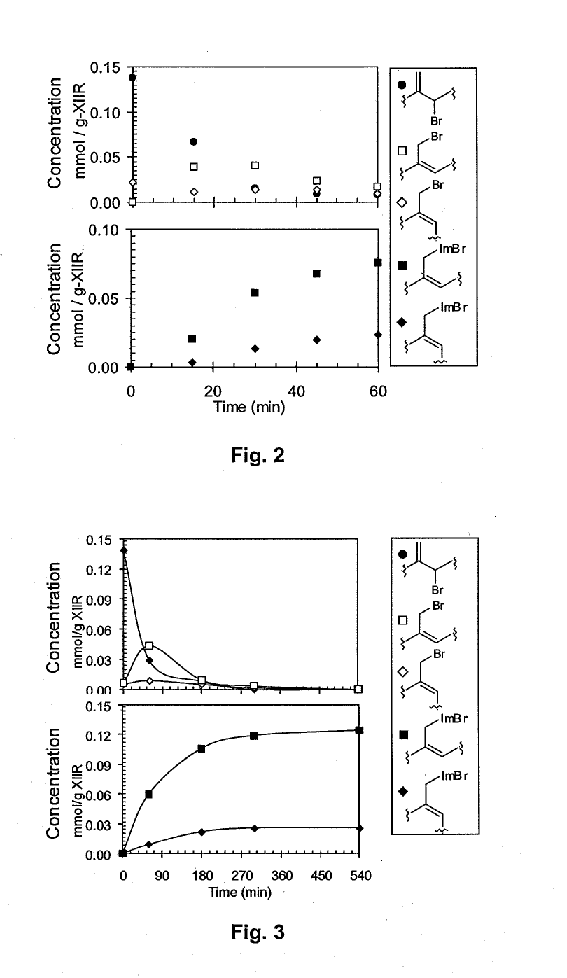

This example illustrates the synthesis of an azolium ionomer under solvent-free conditions. BIIR (40 g, 6.0 mmol of allylic bromide functionality) was mixed with 1-butylimidazole (0.816 g, 6.57 mmole) in a Haake Polylab R600 internal batch mixer equipped with Banbury blades and operating at 85° C. and 60 rpm. Samples taken at specified time intervals were analyzed by ¹H NMR. Residual allylic bromide contents were quantified by ¹H NMR spectrum integration to an estimated accuracy of ±5%: δ 5.01 (Exo-Br, ═CHH 1H, s); δ4.11 (E-BrMe, ═CH—CH₂—Br, 2H, s), δ 4.09 (Z—BrMe, ═CH—CH₂—Br, 2H, s). Imidazolium bromide contents were quantified by integration of the following allylic resonances: δ 4.86 (E-IIR-ImidazoliumBr, s); δ4.95 (Z-IIR-ImidazoliumBr, s). FIG. 2 illustrates the decline of allylic bromide content and the increase of butyl imidazolium bromide functionality, which reaches a total of 0.10 mmoles of functionality per gram of polymer after 60 minutes.

### Example 2

### Solvent-Borne Preparation of an Azolium Ionomer from BIIR and 1-Butyl Imidazole

This example illustrates the synthesis of an azolium ionomer by reaction of BIIR with 1-butylimidazole under solvent-borne conditions. A solution of BIIR (10.0 g, 1.5 mmol) and 1-butylimidazole (1.12 g, 9.0 mmol) in toluene (104 mL) was maintained at 100±2° C. for 6 hours under a nitrogen atmosphere. Aliquots (˜0.5 mL) withdrawn at time intervals were added to excess acetone to isolate the polymeric reaction product, which was dried under vacuum and characterized by ¹H NMR spectroscopy as described in Example 1. The data illustrated in FIG. 3 show that the displacement of bromide from BIIR by 1-butyl imidazole proceeds to full conversion of allylic bromide to imidazolium bromide functionality.

### Example 3

### Stability of Azolium Ionomer Ion Pairs

This example illustrates the stability of ion pairs within an azolium ionomer. An aliquot of the IIR-g-BImBr sample described in Example 2 (4.9 g) was dissolved in toluene (50 g) to create a homogenous solution before adding tetrabutylammonium acetate (0.4532 g, 1.5 mmoles) and heating to 100° C. for 3 hours. The polymer was isolated by precipitation from excess acetone, dried under vacuum, and analyzed by ¹H NMR spectroscopy. The resulting spectrum revealed no change in butyl imidazolium bromide content, indicating that the ion pairs are stable with respect to environmental moisture, and a good nucleophile such as acetate.

### Example 4

### Synthesis of an Azolium Ionomer Derived from CIIR and N-Butyl Imidazole

This example illustrates the synthesis of an azolium ionomer by reaction of CIIR with N-butylimidazole under solvent-borne conditions. A 10 wt % xylene solution of chlorinated butyl rubber comprising 0.02 mmole of exomethylene allylic chloride functionality per gram of polymer and 0.12 mmole of Cl—Me allylic functionality per gram of polymer was heated to 135° C. with 6 molar equivalents of N-butylimidazole for 56 minutes. The reaction product was isolated by precipitation from acetone, dried under vacuum, and analyzed by ¹H-NMR, revealing an N-butylimidazolium chloride content of 0.03 mmole/g.

### Example 5

### Curing of an Azolium Ionomer by Conventional Reactions of its Polymer Backbone

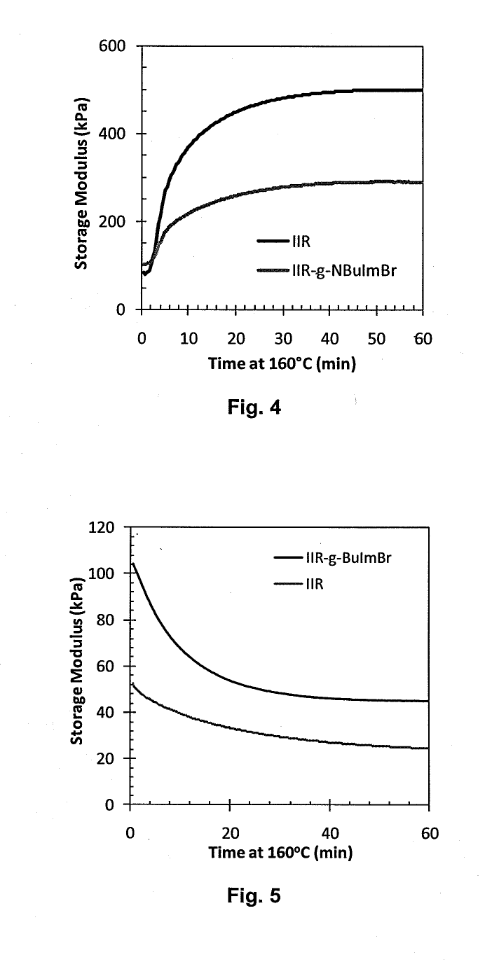

This example illustrates the ability of a filled azolium ionomer to be cured using chemistry that operates on the polymer backbone. IIR (28 g) was mixed with carbon black (8.4 g) stearic acid (0.29 g), ZnO (1.4 g), sulfur (0.39 g), mercaptobenzothiazole (0.42 g) and tetramethylthiruam disulfide (0.28 g) in a Haake Polylab R600 internal batch mixer equipped with Banbury blades and operating at 50° C. and 60 rpm. IIR-g-BuImBr, prepared as described in Example 2, was mixed with this same formulation. The compounds were cured in the cavity of an APA rheometer to generate the data illustrated in FIG. 4. These data show that both IIR and IIR-g-BuImBr can be crosslinked by a conventional sulfur cure formulation. Therefore, IIR-g-BuImBr cures efficiently using cross-linking technology that is designed to cure a polymer backbone comprising isobutylene and isoprene.

### Example 6

### Comparative Example

### Inactivity of IIR and Azolium Ionomers that do not Bear Oligomerizable Functionality in a Free Radical Curing Formulation

This comparative example illustrates the inability of low isoprene grades of butyl rubber to cure when exposed to a free radical generating technique. IIR (5 g) was coated with an acetone solution comprising dicumyl peroxide (0.015 g) and allowed to dry before mixing on a two-roll mill. The compound was heated in the cavity of an APA rheometer to generate the G′ versus time data plotted in FIG. 5. The sample incurred losses to G′, owing to free radical fragmentation of the polymer backbone. As a result, these data show that a low isoprene grade of IIR is not cured by dicumyl peroxide alone. This experiment was repeated using IIR-g-BuImBr in the place of IIR to illustrate the effect of imidazolium bromide ion pairs bearing unreactive alkyl functionality. The data plotted in FIG. 5 show that IIR-g-BuImBr comprising less than 2% isoprene mers did not cure when exposed to DCP. This is because neither the polymer backbone nor the polymer bound ion pairs comprise functionality that engages in free radical oligomerization chemistry to the extent necessary to support a curing process. Higher isoprene contents and the use of appropriate coagents, such as those developed for high isoprene grades of butyl rubber, are expected to produce different results from this comparative example.

### Example 7

### Synthesis and Free-Radical Curing of an Azolium Ionomer Derived from BIIR and N-Vinyl Imidazole

This example illustrates the synthesis and free radical curing of an azolium ionomer whose azolium groups bear oligomerizable functionality. BIIR (10 g) was dissolved in toluene (90 g) prior to the addition of N-vinylimidazole (9.0 mmol, 0.847 g). The resulting solution was maintained at 100° C. for 50 h, and the reaction product, IIR-g-VImBr, was isolated by precipitation from excess acetone. This material was purified by dissolving in tetrahydrofuran, and precipitating into acetone before drying under vacuum. The resulting ionomer, IIR-g-NVImBr, comprises 0.11 mmoles of imidazolium functionality per gram of polymer, as determined by ¹H NMR spectrum integration. This reaction was run multiple times to produce sufficient material for peroxide curing studies.

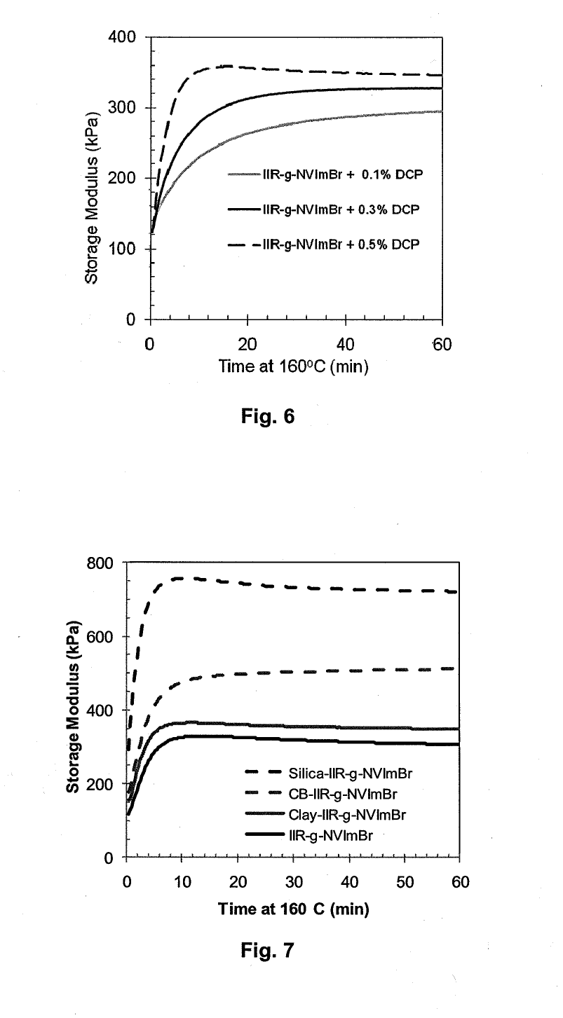

IIR-g-VImBr (5 g) was coated with an acetone solution comprising dicumyl peroxide (0.005 g, 0.015 g, 0.025 g) and allowed to dry before mixing on a two-roll mill to prepare ionomer compounds comprising different peroxide loadings. These compounds were heated in the cavity of an APA rheometer to generate the G′ versus time data plotted in FIG. 6. The data show that IIR-g-NVImBr cures to high storage modulus when treated with a range of peroxide concentrations at 160° C.

### Example 8

### Synthesis and Free-Radical Curing of Azolium Ionomers Derived from BIIR and N-Vinyl Imidazole and Fillers

This example illustrates the synthesis and free radical curing, and physical properties of vulcanizates prepared from filled azolium ionomers whose ion pairs bear oligomerizable functionality. BIIR (130.0 g, 19.5 mmol allylic bromide) and N-vinylimidazole (11.0 g, 117 mmol, 6 eq.) were dissolved in toluene (1300 mL) and heated to 100° C. for 50 h. The N-alkylation product was isolated by precipitation in excess acetone and purified by dissolution/precipitation using tetrahydrofuran/acetone, and dried under vacuum. The resulting ionomer, IIR-g-NVImBr, comprised 0.105 mmoles of imidazolium functionality per gram of polymer, as determined by ¹H NMR spectrum integration.

IIR-g-NVImBr (38.8 g) was mixed with dicumyl peroxide (0.5% wt, 0.2 g) for 5 minutes using a Haake Polylab R600 internal batch mixer, operating at 50° C. and 60 rpm to yield an unfilled comparative sample. A 5 g aliquot of the mixture was cured in the cavity of the APA rheometer at 160° C. for 60 min. The remainder of the mixed compound was sheeted with a two-roll mill and compression molded at 160° C. for 25 min to yield cured sheets of 2.0 mm thickness. These sheets were allowed to condition for 24 hours after compression molding prior to preparing tensile strength specimens according to ASTM D4482-07. Tensile data was acquired at 23±1° C. using an INSTRON Series 3360 universal testing instrument operating at a crosshead speed of 500 mm/min.

IIR-g-NVImBr (37.8 g) was mixed with dicumyl peroxide (0.5% wt, 0.2 g) and NR₄⁺-MM clay (5.0% wt, 2.0 g) to yield a clay-filled sample, Clay-IIR-g-NVImBr. IIR-g-NVImBr (27.8 g) was mixed with dicumyl peroxide (0.5% wt, 0.2 g) and precipitated silica (30% wt, 12.0 g) to yield a silica-filled sample, Silica-IIR-g-NVImBr. IIR-g-NVImBr (27.8 g) was mixed with dicumyl peroxide (0.5% wt, 0.2 g) and carbon black (30% wt, 12.0 g) to yield a carbon black-filled sample, CB-IIR-g-NVImBr. These samples were cured and tested as described above.

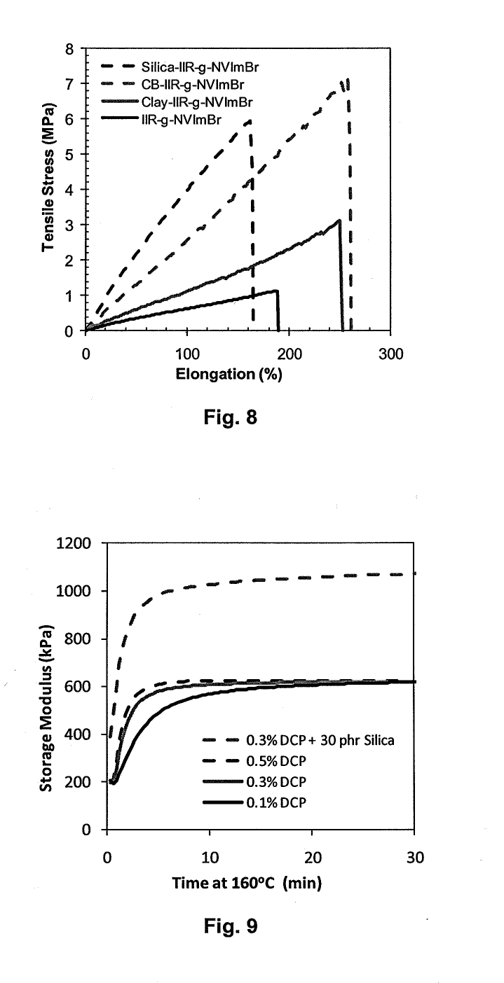

FIG. 7 illustrates peroxide-initiated cures of IIR-g-NVImBr and its filled derivatives. Clay, carbon black and silica did not inhibit the ability of the ionomer to undergo peroxide curing. Moreover, all three fillers increased the storage modulus of the crosslinked ionomer, as expected of reinforcing additives. The tensile data presented in FIG. 8 further illustrate the influence of fillers on mechanical properties, as improvements in Young's modulus and ultimate tensile strength are realized over the unfilled IIR-g-NVImBr vulcanizate.

### Example 9

### Synthesis and Free-Radical Curing of an Azolium Ionomer Derived from BIMS and N-Vinyl Imidazole

This example illustrates the synthesis and peroxide curing of an azolium ionomer by reaction of BIMS with N-vinylimidazole. BIMS (52 g) was dissolved in toluene (500 ml) along with N-vinylimidazole (6.2 g) and BHT (0.26 g) and heated to 100° C. for 12 hours. The reaction product, IMS-g-NVImBr, was recovered by precipitation from acetone, and purified by dissolution precipitation (THF/acetone) before drying under vacuum.

Samples of IMS-g-VImBr (5 g) was coated with an acetone solution comprising dicumyl peroxide (0.005 g, 0.015 g, 0.025 g) and allowed to dry before mixing on a two-roll mill to prepare ionomer compounds comprising different peroxide loadings. These compounds were heated in the cavity of an APA rheometer to generate the G′ versus time data plotted in FIG. 9. The data show that IMS-g-NVImBr cures to high storage modulus when treated with a range of peroxide concentrations at 160° C.

A sample of IMS-g-VImBr (5 g) was coated with an acetone solution comprising dicumyl peroxide (0.015 g) and allowed to dry before mixing with precipitated silica (1.5 g) on a two-roll mill to prepare a filled azolium ionomer compound. Heating this compound in the cavity of an APA rheometer generated the G′ versus time data plotted in FIG. 9, which illustrates the ability of IMS-g-NVImBr to cure efficiently in the presence of reinforcing filler such as silica.

### Example 10

### Free-Radical Curing of an Azolium Ionomer Derived from BIIR and N-Vinyl Imidazole and a Reactive Coagent

This example illustrates the free radical cross-linking of a functional azolium ionomer in the presence of a cure-enhancing coagent. N-vinylimidazole (8.4 g) and n-dodecyl bromide (24.4 g) were mixed and heated to reflux for 24 hours. The resulting mixture was cooled to room temperature, washed with ethyl acetate and dried under vacuum, yielding 3-(n-dodecyl)-1-vinyl imidazolium bromide (hereafter called DVImBr) as white crystals with a melting point range of 47-49° C.

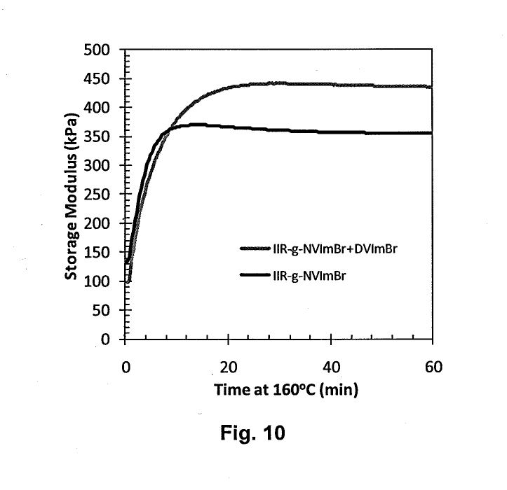

IIR-g-NVImBr (40 g), prepared as described in Example 1, was mixed with DVImBr (5.2 g) for 5 minutes using a Haake Polylab R600 internal batch mixer, operating at 50° C. and 60 rpm. An aliquot (5 g) of this IIR-g-NVImBr+DVImBr mixture was coated with an acetone solution comprising dicumyl peroxide (0.005 g) and allowed to dry before mixing on a two-roll mill. To serve as a coagent-free control compound, IIR-g-NVImBr (5 g) was coated with an acetone solution comprising dicumyl peroxide (0.005 g) and allowed to dry before mixing on two-roll mill. These compounds were cured in the cavity of the APA rheometer to generate the data plotted in FIG. 10. The data show the improvement in storage modulus that was gained by including the coagent in the compound. Furthermore, the cured IIR-g-NVImBr+DVImBr material comprised a higher imidazolium bromide content than the coagent-free IIR-g-NVImBr vulcanizate.

### Example 11

### Synthesis and Moisture Curing of an Azolium Ionomer Derived from BIIR and N-(3-trimethoxysilylpropyl)imidazole

This example illustrates the synthesis and moisture-curing of an azolium ionomer prepared by reaction of BIIR with an azole that bears alkoxysilane functionality. BIIR (40 g) is dissolved in toluene (400 g) and mixed with N-(3-trimethoxysilylpropyl)imidazole (5 g). The resulting solution is heated to 100° C. for 50 hours, and the reaction product is isolated by precipitation from acetone and dried under vacuum to yield IIR-g-SiImBr.

IIR-g-SiImBr (5 g) is mixed with dibutyl tin dilaurate (0.2 g) and hydrated gypsum (1 g) using a two roll mill, and the compound is heated in an APA rheometer to monitor changes in G′ with time. It is predicted that the compound will demonstrate increasing G′ as a result of silane functionality bound to imidazolium ion pairs.

### Example 12

### Synthesis and Free-Radical Curing of an Azolium Ionomer Derived from Brominated Polypropylene and N-Vinyl Imidazole

Atactic polypropylene (5 g) is dissolved in carbon tetrachloride (50 g) prior to the addition of Br₂ (0.2 g) and azobisisobutyronitrile (AIBN, 0.005 g). The resulting mixture is heated to 60° C. for 8 hours, and the product recovered by precipitation from methanol and drying under vacuum, yielding brominated polypropylene (BPP).

BPP (5 g) and N-vinyl imidazole (0.8 g) are dissolved in toluene (50 g) and heated to 110° C. for 12 hours. The product, PP-g-NVImBr, is isolated by precipitation from methanol, dried under vacuum and mixed with dicumyl peroxide (0.02 g). The resulting compound is heated in an APA rheometer to monitor changes in G′ with time. It is predicted that the compound will demonstrate increasing G′ as a result of vinyl functionality bound to imidazolium ion pairs.

### Example 13

### Synthesis and Free-Radical Curing of an Azolium Ionomer Derived from Brominated EPDM and N-Vinyl Imidazole

EPDM (5 g) is dissolved in hexane (50 g) prior to the addition of Br₂ (0.2 g). The resulting mixture is maintained at 40° C. for 3 hours, and the product recovered by precipitation from methanol and drying under vacuum, yielding brominated EPDM (BEPDM).

BEPDM (5 g) and N-vinyl imidazole (0.8 g) are dissolved in toluene (50 g) and heated to 110° C. for 12 hours. The product, EPDM-g-NVImBr, is isolated by precipitation from methanol, dried under vacuum and mixed with dicumyl peroxide (0.02 g). The resulting compound is heated in an APA rheometer to monitor changes in G′ with time. It is predicted that the compound will demonstrate increasing G′ as a result of vinyl functionality bound to imidazolium ion pairs.

### Example 14

### Enhanced Adhesion

IIR-g-BumBr is prepared as described in Example 1. The resulting compound is tested using ASTM standard D413 and D429-08 for adhesion to flexible and rigid substrates, respectively. This material displays enhanced adhesion to metals, ceramics, mylar, plastics, Teflon and glass.

### Example 15

### Resistance to Microorganism Growth

IIR-g-VImBr is prepared and cured as described in Examples 7 and 10. These materials display resistance to the growth of gram positive bacteria, gram negative bacteria, algae and fungi.

### Example 16

### Enhanced Tensile and Flex Fatigue Properties of a Cured Azolium Ionomer Derived from BIMS and N-Vinyl Imidazole

BIMS (40 g, 7.6 mmol benzylic bromide) was mixed with N-vinylimidazole (0.36 g, 3.8 mmol, 0.5 eq.) and BuIm (0.47 g, 3.8 mmol, 0.5 eq.) and BHT (0.008 g, 200 ppm) at 130° C. and 60 rpm using a Haake Polylab R600 internal batch mixer, yielding IMS-g-VImBr. This material was then mixed with 0.5 wt % DCP, at 100° C. and 60 rpm for 10 min. The resulting compound was sheeted with a two-roll mill and compression molded at 160° C. and 20 MPa for 25 min. The sheeted products had a thickness of 2.00±0.05 mm. Tensile strength data were acquired using an INSTRON Series 3360 universal testing instrument, operating at a crosshead speed of 500 mm/min at 23±1° C. Dogbones were cut from the specimen cutter described in ASTM D4482. Four replicate measurements were made for each sample to test the precision of the compounding and physical testing procedures, with data expressed in terms of arithmetic means. Flex fatigue data were acquired by repeated tensile elongation to a fixed strain of 80% at 100 cycles per minute at room temperature, with data reported as the number of strain cycles endured before sample failure.

A thermoset material containing no polymer-bound ion pairs was prepared by peroxide-vulcanization of a BIIR-derived macromonomer, IIR-g-dodecyl itaconate, which was prepared as follows. 1-Dodecanol (80.0 mmol, 15 g) and itaconic anhydride (87 mmol, 9.74 g), were dissolved in toluene (50 g) and heated to 80° C. for 4 hr. Residual starting materials and solvent were removed by Kugelrohr distillation (T=80° C., P=0.6 mmHg). The resulting acid-ester, monododecyl itaconate, was isolated and dried. Monododecyl itaconate (7.2 g, 24.3 mmol) was treated with a 1M solution of Bu₄NOH in methanol (24 ml, 24 mmol Bu₄NOH) to yield a Bu₄Ncarboxylate salt, which was isolated by removing methanol under vacuum. BIIR (160 g) and Bu₄NBr (7 g, 21.7 mmol) were dissolved in toluene (1450 g) and heated to 85° C. for 180 min. Bu₄Ncarboxylate salt (13.2 g, 24.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-dodecyl itaconate. ¹H-NMR (CDCl₃): δ 6.24 (s, CH₂═C(CH₂)—COO—, 1H), δ 5.62 (s, CH₂═C(CH₂)—COO—, 1H), δ 3.36 (s, CH₂═C(CH₂)—COO—, 2H), δ 4.54 (E-ester, ═CH—CH₂—OCO—, 2H, s), δ 4.60 (Z-ester, ═CH—CH₂—OCO—, 2H, s). This macromonomer was cured by mill mixing with 0.5% dicumyl peroxide before compression molding as described above to give a non-ionic thermoset, which was then subjected to the same tensile and flex fatigue analyses used for the thermoset azolium ionomer.

The data provided in the following table demonstrate that the cured azolium ionomer provides superior flex fatigue, Young's modulus and tensile strength.

| | Cured Azolium | Non-ionic |
|---|---|---|
| | Ionomer | Thermoset |
| Flex Fatigue (cycles to failure) | >12000 | 600 |
| Young's Modulus (MPa) | 1.00 | 0.39 |
| Elongation at Break (%) | 450 | 640 |
| Tensile at Break (MPa) | 5.2 | 0.7 |

### Example 17

### Enhanced Dynamic Properties of a Cured Azolium Ionomer Derived from BIIR and N-Vinyl Imidazole

IIR-g-VImBr was prepared and mixed with 0.5 wt % DCP as described in Example 7. A non-ionic macromonomer was prepared as follows. BIIR (20 g, 3.0 mmol allylic bromide) was dissolved in toluene (200 mL, 10 wt %) and heated to 85±2° C. Tetra-N-butylammonium bromide (0.48 g, 0.5 mmol, 0.5 eq.) was added to the solution to isomerize from 1 to 2a/2b. Tetra-N-butylammonium acrylate (1.03 g, 3.3 mmol, 1.1 eq.) was added to the solution and allowed to react for 2 hours to ensure allylic bromide conversion. The esterification product was obtained by precipitation in excess acetone and purified by dissolution/precipitation using tetrahydrofuran/acetone and dried in vacuo. This material, IIR-g-Acrylate, was mixed with 0.5 wt % DCP.

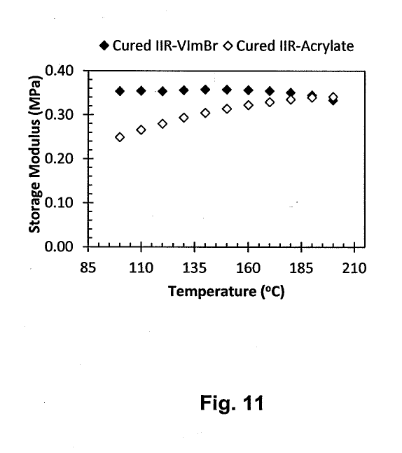

Both materials were cured in the cavity of an APA rheometer as described in Example 7, and subjected to rheological analysis from 100° C. to 200° C. at 10° C. intervals. The data plotted in FIG. 11 show that the storage modulus of the cured azolium ionomer does not change with temperature, whereas the storage modulus of non-ionic thermoset increases with increasing temperature. Hence, the cured azolium ionomer provides more consistent rheological properties throughout this temperature range.

It will be understood by those skilled in the art that this description is made with reference to certain embodiments and that it is possible to make other embodiments employing the principles of the invention which fall within its spirit and scope as defined by the claims.

1. An azolium ionomer comprising: 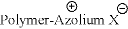
where X is an anion.

2. The azolium ionomer of claim 1, wherein the azolium ionomer is of formula (12), 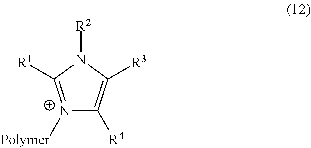
wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear one or more functional moieties;
R² is a substituted or unsubstituted olefin, a substituted or unsubstituted C₁ to about C₁₆ aliphatic group, a substituted or unsubstituted C₁ to about C₁₆ aryl group, or a combination thereof, and optionally bears one or more functional moieties; and
optionally, any combination of R¹, R², R³ and R⁴ together with the azole ring atoms to which they are bonded form a cyclic structure.

3. The azolium ionomer of claim 1, wherein the azolium cation is 1-decyl-2-methyl-3-alkylimidazolium, 1-(2-hydroxyethyl)-3-alkyl imidazolium, 1-butyl-3-alkyl-benzimidazole, N-butyl imidazolium, N-(trimethylsilyl)imidazolium, N-decyl-2-methylimidazolium, or N-hydroxyethyl imidazolium, N-(3-trimethoxysilylpropyl) imidazolium, N-vinylimidazolium, 2-(imidazol-1-yl)ethyl 2-methyl-2-propenoate, 1-butylbenzimidazolium, or any combination thereof.

4. The azolium ionomer of claim 1, wherein the azolium ionomer is of formula (13), 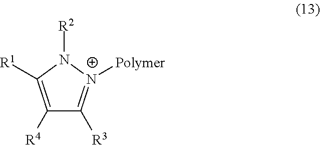
wherein R¹, R³ and R⁴ are independently hydrogen, silane, a substituted or unsubstituted C₁ to about C₁₆ aliphatic group, a substituted or unsubstituted C₁ to about C₁₆ aryl group, or a combination thereof, and optionally bear a functional moiety;
R² is a substituted or unsubstituted C₁ to about C₁₆ aliphatic group, a substituted or unsubstituted C₁ to about C₁₂ aryl group, or a combination thereof, and optionally bears a functional moiety; and
optionally, any combination of R¹, R², R³ and R⁴ together with the azole ring atoms to which they are bonded form a cyclic structure.

5. The azolium ionomer of claim 4, wherein the azolium cation is N-(3-trimethoxysilylpropyl)pyrazole, N-vinylpyrazole, or a combination thereof.

6. The azolium ionomer of claim 1, wherein the azolium ionomer is of formula (14), 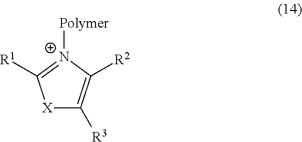
wherein X is sulphur or oxygen;
R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality moiety; and
optionally, R² and R³ taken together with the azole ring atoms to which they are bonded form a cyclic structure.

7. The azolium ionomer of claim 6, wherein the azolium cation is oxazolium, benzothiazolium, or a combination thereof.

8. The azolium ionomer of claim 1, wherein the azolium cation is a triazolium.

9. The azolium ionomer of claim 1, wherein the azolium ionomer is of formula (15), 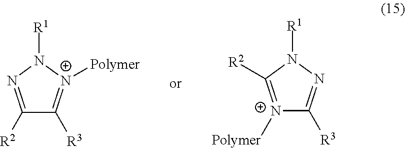
wherein R¹ is a substituted or unsubstituted C₁ to about C₁₆ aliphatic group, a substituted or unsubstituted C₁ to about C₁₆ aryl group, or a combination thereof, and optionally bears a functional moiety;
R² and R³ are independently hydrogen, silane, a substituted or unsubstituted C₁ to about C₁₆ aliphatic group, a substituted or unsubstituted C₁ to about C₁₂ aryl group, or a combination thereof, and optionally bear a functional moiety; and
optionally, any combination of R¹, R², and R³ together with the azole ring atoms to which they are bonded form a cyclic structure.

10. The azolium ionomer of claim 8, wherein the triazolium cation is

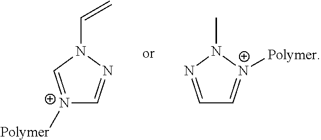

11. The azolium ionomer of claim 1, wherein the polymer moiety is a derivative of BIIR, CIIR, BIMS, polychloroprene, halogenated EPDM (ethylene propylene diene monomer), halogenated polypropylene, halogenated polyethylene, halogenated ethylene-propylene copolymers, or a combination thereof.

12. The azolium ionomer of claim 1, further comprising filler.

13. The azolium ionomer of claim 12, wherein the filler comprises carbon black, silica, clay, glass fibres, polymeric fibres, finely divided minerals, crystalline cellulose, or a combination thereof.

14. The azolium ionomer of claim 12, wherein the amount of filler is from about 10 to about 60 wt % or from about 20 to about 45 wt %.

15. (canceled)

16. The azolium ionomer of claim 12, wherein the filler comprises nano-scale filler.

17. The azolium ionomer of claim 16, wherein the nano-scale filler comprises exfoliated clay platelets, sub-micron particles of carbon black, sub-micron particles of siliceous fillers, or a combination thereof.

18. The azolium ionomer of claim 17, wherein the amount of nano-scale filler is from about 0.5 to about 30 wt % or from about 2 to about 10 wt %.

19. (canceled)

20. The azolium ionomer of claim 1, further comprising antioxidant, wax, reinforcing filler, non-reinforcing filler, ultraviolet radiation stabilizer, anti-ozone stabilizing compound, tackifier, oil, soap, or a combination thereof.

21. The azolium ionomer of claim 20, wherein the antioxidant comprises a phenolic, an amine, or a combination thereof.

22. The azolium ionomer of claim 1, wherein the anion is carboxylate, sulphate, sulfonate, borate, phosphate, phosphonate, or phosphinate.

23. The azolium ionomer of claim 1, comprising two anions, which are, independently, carboxylate, sulfate, sulfonate, borate, phosphate, phosphonate, or phosphinate.

24. The azolium ionomer of claim 1, further comprising an anion, which is persulfate, bis(dimethylallyl)pyrophosphate, etidronate, or conjugate base of adipic acid.

25. IIR-g-BuImBr or IIR-g-vinylImBr.

26. (canceled)

27. The azolium ionomer of claim 1, wherein the azolium ionomer provides superior adhesion relative to a non-ionic analogue of the polymer.

28. The azolium ionomer of claim 1, wherein the azolium ionomer provides superior adhesion to glass, mylar, plastic, mineral, metal, ceramic, or a combination thereof.

29. The azolium ionomer of claim 1, wherein the azolium ionomer reduces a population of organisms or prevents accumulation of organisms (e.g., bacteria, algae, fungi, mollusks, arthropods).

30-31. (canceled)

32. The azolium ionomer of claim 29, wherein the organisms comprise Gram-negative bacteria or Gram-positive bacteria.

33. A method of making azolium ionomer, comprising:
reacting halogenated polymer and an azole.

34-52. (canceled)

53. A cured polymeric product prepared by subjecting the azolium ionomer of claim 1 to an appropriate trigger for curing.

54-63. (canceled)

64. The cured polymeric product of claim 53, wherein the azolium ionomer is mixed with a co-agent prior to subjecting the mixture to the appropriate trigger.

65-73. (canceled)

74. Cured polymeric product derived from crosslinking azolium ionomers [1-(3-trimethoxysilylpropyl)-3-alkyl-imidazolium] [Br⁻], IIR-g-BuImBr, or IIR-g-VImBr.

75-112. (canceled)

113. An article comprising the azolium ionomer of claim 1.

114-119. (canceled)

120. The article of claim 113, wherein the article is fuel cell membrane, pharmaceutical stopper, syringe fitting, ion-exchange resin, separation membrane, bathroom safety equipment, garden equipment, spa equipment, water filtration equipment, caulking, sealant, grout, contact cement, adhesive, pressure sensitive adhesive, tank liner, membrane, packaging material, cell culture equipment, light switch, exercise equipment, railing, sports equipment, steering wheel, writing tool, luggage, o-ring, tire inner liner, tire tread, thermoplastic vulcanizate (TPV), gasket, appliance, baby product, bottle, lid, toilet seat, bathroom fixture, flooring, surface, surface for food preparation, utensil, handle, grip, gardening tool, kitchen fixture, kitchen product, office product, pet product, water storage equipment, food preparation equipment, shopping cart, surfacing material, storage container, food storage container, footwear, protective wear, sporting gear, cart, dental equipment, door knob, clothing, handheld device, telephone, toy, container for fluid, catheter, keyboard, surface of vessel, surface of pipe, surface of duct, coating, food processing equipment, materials handling equipment, auger, conveyor belt, biomedical device, filter, additive, computer, dock, drilling platform, ship hull, underwater infrastructure, HVAC equipment, shower wall, shower flooring, implant, medical textile, tissue sealant, tissue adhesive, personal protective equipment, wetsuit, drysuit, respiratory mask, article to minimize biofouling, pacemaker, wound dressing, ice machine, water cooler, fruit juice dispenser, soft drink machine, piping, storage vessel, metering system, valve, fitting, attachment, filter housing, lining, barrier coating, insulation, chemical protective equipment, or biochemical protective equipment.

121. The azolium ionomer of claim 1, wherein the azolium ionomer provides superior mechanical properties relative to a non-ionic analogue of the polymer.

122. The azolium ionomer of claim 1, wherein the azolium ionomer provides superior static properties, superior dynamic properties, or both superior static properties and superior dynamic properties relative to a non-ionic analogue of the polymer.

123. (canceled)

124. The azolium ionomer of claim 122, wherein the static property is compression set resistance and/or wherein the dynamic property is flex fatigue.

125-135. (canceled)
